(19) United States
(12) Patent Application Publication
(10) Pub. No.: US 2024/0314375 A1
(43) Pub. Date: Sep. 19, 2024

(54) MEDIA PROCESSING APPARATUS, MEDIA PROCESSING METHOD, AND MEDIA PROCESSING PROGRAM

(71) Applicant: NIPPON TELEGRAPH AND TELEPHONE CORPORATION, Tokyo (JP)

(72) Inventors: Maiko IMOTO, Musashino-shi, Tokyo (JP); Shinji FUKATSU, Musashino-shi, Tokyo (JP); Hiromu MIYASHITA, Musashino-shi, Tokyo (JP)

(73) Assignee: NIPPON TELEGRAPH AND TELEPHONE CORPORATION, Tokyo (JP)

(21) Appl. No.: 18/576,109

(22) PCT Filed: Jul. 7, 2021
(86) PCT No.: PCT/JP2021/025654

§ 371 Date: Jan. 3, 2024

(51) Int. Cl. H04N 21/238; H04N 21/24

(52) U.S. Cl. CPC H04N 21/23805; H04N 21/2402; H04N 21/2407

(57) ABSTRACT

A medium processing device of a second base different from a first base, including a first reception unit that receives, from an electronic device in the first base, notification regarding a transmission delay time based on a first time at which a medium is acquired in the first base and a second time associated with reception, by an electronic device in the first base, of a packet regarding a medium acquired in the second base at a time at which the medium is reproduced in the second base. Further, there is a second reception unit that receives a packet that stores a first medium acquired in the first base from an electronic device in the first base and outputs the first medium to a presentation device, a processing unit that generates a third medium, and a transmitter that transmits the third medium to an electronic device in the first base.

### TECHNICAL FIELD

One aspect of the present invention relates to a medium processing device, a medium processing method, and a medium processing program.

### BACKGROUND ART

In recent years, a video/audio reproduction device that digitizes a video/audio obtained by capturing and recording at a certain point, transmits the digitized video/audio to a remote location in real time via a communication line such as an Internet Protocol (IP) network, and reproduces the video/audio in the remote location has been used. For example, public viewing or the like in which a video/audio of a sports competition held at a competition site or a video/audio of a music concert held at a concert site are transmitted to a remote location in real time is actively performed. Such video/audio transmission is not limited to one-to-one unidirectional transmission. Bidirectional transmission is also performed in which a video/audio is transmitted from a site where a sports competition is held (hereinafter, referred to as an event site) to a plurality of remote locations, a video of an audience who enjoys the event and an audio of cheers and the like are obtained by capturing and recording in each of the plurality of remote locations, the video/audio is transmitted to the event site or another remote location, and the video/audio are output from a large video display device or a speaker at each base.

By such bidirectional transmission of a video/audio, players (or performers) and an audience in an event site, and viewers in a plurality of remote locations can obtain a realistic feeling and a sense of unity as if they were in the same space (event site) and having the same experience even though they were physically located away from each other.

A real-time transport protocol (RTP) is often used in real-time transmission of a video/audio by an IP network, but a data transmission time between two bases varies depending on a communication line or the like connecting the two bases. For example, a case is considered in which a video/audio obtained by capturing and recording at a time T at an event site A is transmitted to two remote locations B and C, and a video/audio obtained by capturing and recording in each of the remote locations B and C is returned and transmitted to the event site A. The video/audio obtained by capturing and recording at the time T and transmitted from the event site A in the remote location B is reproduced at a time T_{b1} and a video/audio obtained by capturing and recording at the time T_{b1} in the remote location B is returned and transmitted to the event site A and reproduced at a time T_{b2} at the event site A. At this time, the video/audio obtained by capturing and recording at the time T and transmitted at the event site A may be reproduced at a time T_{c1} (≠T_{b1}) in the remote location C and a video/audio obtained by capturing and recording at the time T_{c1} in the remote location C may be returned and transmitted to the event site A and reproduced at a time T_{c2} (≠T_{b2}) at the event site A.

In such a case, players (or performers) and an audience in the event site A view videos/audios indicating how viewing in the plurality of remote locations has reacted to an event experienced by themselves at the time T at different times (time T_{b2} and time T_{c2}). For the players (or performers) and the audience in the event site A, enhancing a sense of unity with the audience in the remote locations may be difficult because lack of intuitive comprehension or unnaturalness of connection with their own experience is caused. Furthermore, also when the video/audio transmitted from the event site A and the video/audio transmitted from the remote location B are reproduced in the remote location C, the audience in the remote location C may feel the above-described lack of intuitive comprehension or unnaturalness.

In order to eliminate such lack of intuitive comprehension or unnaturalness, conventionally, a method of synchronously reproducing a plurality of videos/plurality of audios transmitted from a plurality of remote locations in the event site A is used. In a case where reproduction timings of videos/audios are synchronized, time synchronization is performed using a network time protocol (NTP), a precision time protocol (PTP), or the like so that both the transmission side and the reception side manage the same time information, and video/audio data is packetized into RTP packets at the time of transmission. At this time, in general, an absolute time of a moment of sampling the videos/audios is provided as an RTP time stamp, and the reception side delays at least one or more videos and audios of videos and audios on the basis of the time information to adjust timings, and synchronizes the videos/audios (Non Patent Literature 1).

### CITATION LIST

### Non Patent Literature

Non Patent Literature 1: Synchronization for Acoustic Signals over IP Network (Tokumoto, Ikedo, Kaneko, Kataoka, the transactions of the Institute of Electronics, Information and Communication Engineers D-II Vol. J87-D-II No. 9 pp. 1870-1883)

### SUMMARY OF INVENTION

### Technical Problem

However, in the conventional video/audio reproduction synchronization method, a reproduction timing is matched with a video or audio having the largest delay time, and there is an issue that the real-time property of reproduction timings of videos/audios is lost, and discomfort felt by viewers is difficult to be reduced. That is, reproduction of videos/audios needs to be devised so that the above-described discomfort felt by viewers when a plurality of videos/audios transmitted from a plurality of bases is reproduced at different times is reduced. Furthermore, a data transmission time of videos/audios transmitted from a plurality of bases needs to be shortened.

The present invention has been made in view of the above circumstances, and an object of the present invention is to provide a technology of reducing discomfort felt by viewers when a plurality of videos/audios transmitted from a plurality of bases at different times is reproduced.

### Solution to Problem

In an embodiment of the present invention, a medium processing device is a medium processing device of a second base different from a first base, including a first reception unit that receives, from an electronic device in the first base, notification regarding a transmission delay time based on a first time at which a medium is acquired in the first base and a second time associated with reception, by an electronic device in the first base, of a packet regarding a medium acquired in the second base at a time at which the medium is reproduced in the second base, a second reception unit that receives a packet that stores a first medium acquired in the first base from an electronic device in the first base and outputs the first medium to a presentation device, a processing unit that generates a third medium from a second medium acquired in the second base at a time at which the first medium is reproduced in the second base according to a processing mode based on the transmission delay time, and a transmission unit that transmits the third medium to an electronic device in the first base.

### Advantageous Effects of Invention

According to one aspect of the present invention, discomfort felt by viewers when a plurality of videos/audios transmitted from a plurality of bases at different times is reproduced can be reduced.

### BRIEF DESCRIPTION OF DRAWINGS

FIG. 1 is a block diagram illustrating an example of a hardware configuration of each electronic device included in a medium processing system according to a first embodiment.

FIG. 2 is a block diagram illustrating an example of a software configuration of each electronic device included in the medium processing system according to the first embodiment.

FIG. 3 is a diagram illustrating an example of a data structure of a video time management DB included in a server of a base R₁ according to the first embodiment.

FIG. 4 is a diagram illustrating an example of a data structure of an audio time management DB included in the server of the base R₁ according to the first embodiment.

FIG. 5 is a flowchart illustrating a video processing procedure and processing content of a server in a base O according to the first embodiment.

FIG. 6 is a flowchart illustrating a video processing procedure and processing content of the server in the base R₁ according to the first embodiment.

FIG. 7 is a flowchart illustrating a transmission processing procedure and processing content of an RTP packet that stores a video V_{signal} of the server in the base O according to the first embodiment.

FIG. 8 is a flowchart illustrating a reception processing procedure and processing content of an RTP packet that stores a video V_{signal1} of the server in the base R₁ according to the first embodiment.

FIG. 9 is a flowchart illustrating a calculation processing procedure and processing content of a presentation time t₁ of the server in the base R₁ according to the first embodiment.

FIG. 10 is a flowchart illustrating a reception processing procedure and processing content of an RTP packet that stores a video V_{signal3} of the server in the base O according to the first embodiment.

FIG. 11 is a flowchart illustrating a transmission processing procedure and processing content of an RTCP packet that stores Δd_{x_video} of the server in the base O according to the first embodiment.

FIG. 12 is a flowchart illustrating a reception processing procedure and processing content of an RTCP packet that stores Δd_{x_video} of the server in the base R₁ according to the first embodiment.

FIG. 13 is a flowchart illustrating a process processing procedure and processing content of a video V_{signal2} of the server in the base R₁ according to the first embodiment.

FIG. 14 is a flowchart illustrating a transmission processing procedure and processing content of an RTP packet that stores a video V_{signal3} of the server in the base R₁ according to the first embodiment.

FIG. 15 is a flowchart illustrating an audio processing procedure and processing content of the server in the base O according to the first embodiment.

FIG. 16 is a flowchart illustrating an audio processing procedure and processing content of the server in the base R₁ according to the first embodiment.

FIG. 17 is a flowchart illustrating a transmission processing procedure and processing content of an RTP packet that stores an audio A_{signal1} of the server in the base O according to the first embodiment.

FIG. 18 is a flowchart illustrating a reception processing procedure and processing content of an RTP packet that stores an audio A_{signal1} of the server in the base R₁ according to the first embodiment.

FIG. 19 is a flowchart illustrating a reception processing procedure and processing content of an RTP packet that stores an audio A_{signal3} of the server in the base O according to the first embodiment.

FIG. 20 is a flowchart illustrating a transmission processing procedure and processing content of an RTCP packet that stores Δd_{x_audio} of the server in the base O according to the first embodiment.

FIG. 21 is a flowchart illustrating a reception processing procedure and processing content of an RTCP packet that stores Δd_{x_audio} of the server in the base R₁ according to the first embodiment.

FIG. 22 is a flowchart illustrating a process processing procedure and processing content of an audio A_{signal2} of the server in the base R₁ according to the first embodiment.

FIG. 23 is a flowchart illustrating a transmission processing procedure and processing content of an RTP packet that stores an audio A_{signal3} of the server in the base R₁ according to the first embodiment.

FIG. 24 is a block diagram illustrating an example of a hardware configuration of each electronic device included in a medium processing system according to a second embodiment.

FIG. 25 is a block diagram illustrating an example of a software configuration of each electronic device included in the medium processing system according to the second embodiment.

FIG. 26 is a diagram illustrating an example of a data structure of an audio time management DB included in a server of a base R₂ according to the second embodiment.

FIG. 27 is a flowchart illustrating a video processing procedure and processing content of a server in a base R₁ according to the second embodiment.

FIG. 28 is a flowchart illustrating a video processing procedure and processing content of the server in the base R₂ according to the second embodiment.

FIG. 29 is a flowchart illustrating a transmission processing procedure and processing content of an RTCP packet that stores Δd_{x_video} of the server in the base R₂ according to the second embodiment.

FIG. 30 is a flowchart illustrating an audio processing procedure and processing content of the server in the base R₁ according to the second embodiment.

FIG. 31 is a flowchart illustrating an audio processing procedure and processing content of the server in the base R₂ according to the second embodiment.

FIG. 32 is a flowchart illustrating a reception processing procedure and processing content of an RTP packet that stores an audio A_{signal1} of the server in the base R₂ according to the second embodiment.

FIG. 33 is a flowchart illustrating a calculation processing procedure and processing content of a presentation time t₂ of the server in the base R₂ according to the second embodiment.

FIG. 34 is a flowchart illustrating a transmission processing procedure and processing content of an RTCP packet that stores Δd_{x_audio} of the server in the base R₂ according to the second embodiment.

### DESCRIPTION OF EMBODIMENTS

Hereinafter, some embodiments according to the present invention will be described with reference to the drawings.

Time information uniquely determined with respect to an absolute time at which a video/audio is obtained by capturing and recording in a base O serving as an event site such as a competition site or a concert site is provided to a video/audio transmitted to bases R₁ to Rₙ (n is an integer of 2 or more) in a plurality of remote locations. In each of the bases R₁ to Rₙ, a video/audio obtained by capturing and recording at a time at which a video/audio having the time information is reproduced is processed on the basis of the time information and a data transmission time to a transmission destination base. The processed video/audio is transmitted to the base O or another base R.

The time information is transmitted and received between the base O and each of the bases R₁ to Rₙ by any one of the following means. The time information is associated with a video/audio obtained by capturing and recording in each of the bases R₁ to Rₙ.
(1) The time information is stored in a header extension area of an RTP packet transmitted and received between the base O and each of the bases R₁ to Rₙ. For example, the time information is in an absolute time format (hh:mm:ss.fff format), but may be in a millisecond format.
(2) The time information is described using an application-defined (APP) in an RTP control protocol (RTCP) transmitted and received at constant intervals between the base O and each of the bases R₁ to Rₙ. In this example, the time information is in a millisecond format.
(3) The time information is stored in a session description protocol (SDP) that describes initial value parameters exchanged between the base O and each of the bases R₁ to Rₙ at the start of transmission. In this example, the time information is in a millisecond format.

### First Embodiment

A first embodiment is an embodiment in which videos/audios transmitted from the bases R₁ to Rₙ back in the base O are reproduced.

Time information used for processing a video/audio is stored in a header extension area of an RTP packet transmitted and received between the base O and each of the bases R₁ to Rₙ. For example, the time information is in an absolute time format (hh:mm:ss.fff format). An RTP packet is an example of a packet.

Although a video and an audio are described as being transmitted and received in RTP packetization, the present invention is not limited thereto. The video and audio may be processed and managed by the same functional unit/database (DB). Both the video and audio may be stored in one RTP packet and transmitted and received. The video and audio are examples of a medium.

### Configuration Example

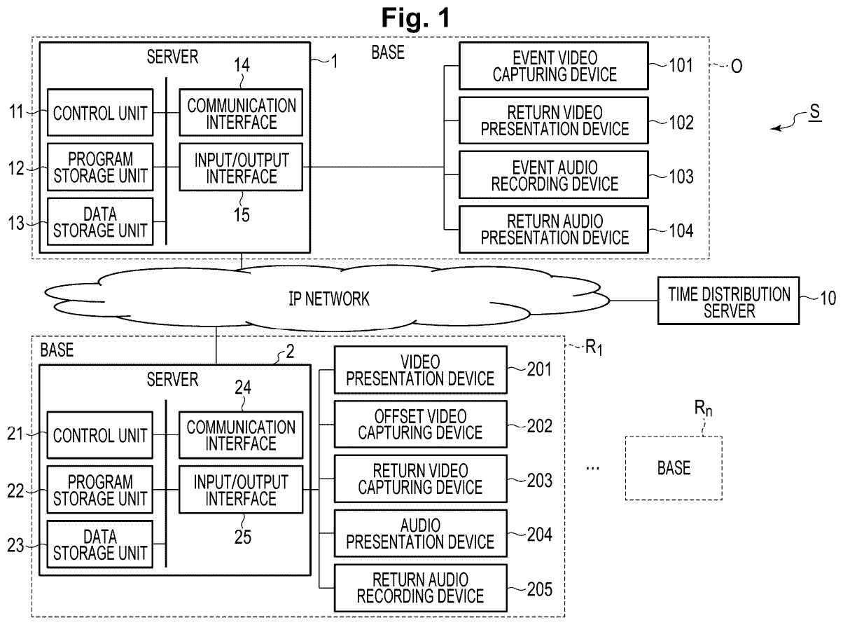

FIG. 1 is a block diagram illustrating an example of a hardware configuration of each electronic device included in a medium processing system S according to the first embodiment.

The medium processing system S includes a plurality of electronic devices included in the base O, a plurality of electronic devices included in each of the bases R₁ to Rₙ, and a time distribution server 10. The electronic devices in each of the bases and the time distribution server 10 can communicate with each other via an IP network.

The base O includes a server 1, an event video capturing device 101, a return video presentation device 102, an event audio recording device 103, and a return audio presentation device 104. The base O is an example of a first base.

The server 1 is an electronic device that controls each of the electronic devices included in the base O.

The event video capturing device 101 is a device including a camera that captures a video of the base O. The event video capturing device 101 is an example of a video capturing device.

The return video presentation device 102 is a device including a display that reproduces and displays a video returned and transmitted from each of the bases R₁ to Rₙ to the base O. For example, the display is a liquid crystal display. The return video presentation device 102 is an example of a video presentation device or a presentation device.

The event audio recording device 103 is a device including a microphone that records an audio of the base O. The event audio recording device 103 is an example of an audio recording device.

The return audio presentation device 104 is a device including a speaker that reproduces and outputs an audio returned and transmitted from each of the bases R₁ to Rₙ to the base O. The return audio presentation device 104 is an example of an audio presentation device or a presentation device.

A configuration example of the server 1 will be described.

The server 1 includes a control unit 11, a program storage unit 12, a data storage unit 13, a communication interface 14, and an input/output interface 15. The elements included in the server 1 are connected to each other via a bus.

The control unit 11 corresponds to a central part of the server 1. The control unit 11 includes a processor such as a central processing unit (CPU). The control unit 11 includes a read only memory (ROM) as a nonvolatile memory area. The control unit 11 includes a random access memory (RAM) as a volatile memory area. The processor deploys the ROM or a program stored in the program storage unit 12 in the RAM. The processor executes a program deployed in the RAM, thereby the control unit 11 implements each functional unit described below. The control unit 11 is included in a computer.

The program storage unit 12 includes a non-volatile memory capable of writing and reading as needed, such as a hard disk drive (HDD) or a solid state drive (SSD) as a storage medium. The program storage unit 12 stores programs necessary for executing various types of control processing. For example, the program storage unit 12 stores a program for causing the server 1 to execute processing by each functional unit to be described below implemented by the control unit 11. The program storage unit 12 is an example of a storage.

The data storage unit 13 includes a non-volatile memory capable of writing and reading as needed, such as an HDD or an SSD as a storage medium. The data storage unit 13 is an example of a storage or a storage unit.

The communication interface 14 includes various interfaces that communicatively connect the server 1 to other electronic devices using a communication protocol defined by the IP network.

The input/output interface 15 is an interface that enables communication between the server 1 and each of the event video capturing device 101, the return video presentation device 102, the event audio recording device 103, and the return audio presentation device 104. The input/output interface 15 may include an interface for wired communication or an interface for wireless communication.

Note that a hardware configuration of the server 1 is not limited to the above-described configuration. The server 1 can appropriately omit and change the above-described components and add a new component.

The base R₁ includes a server 2, a video presentation device 201, an offset video capturing device 202, a return video capturing device 203, an audio presentation device 204, and a return audio recording device 205. The base R₁ is an example of a second base different from the first base.

The server 2 is an electronic device that controls each of the electronic devices included in the base R₁. The server 2 is an example of a medium processing device.

The video presentation device 201 is a device including a display that reproduces and displays a video transmitted from the base O to the base R₁. The video presentation device 201 is an example of the presentation device.

The offset video capturing device 202 is a device capable of recording a capturing time. The offset video capturing device 202 is a device including a camera installed so as to be able to capture the entire video display area of the video presentation device 201. The offset video capturing device 202 is an example of the video capturing device.

The return video capturing device 203 is a device including a camera that captures a video of the base R₁. For example, the return video capturing device 203 captures a video of a state of the base R₁ where the video presentation device 201 that reproduces and displays a video transmitted from the base O to the base R₁ is installed. The return video capturing device 203 is an example of the video capturing device.

The audio presentation device 204 is a device including a speaker that reproduces and outputs an audio transmitted from the base O to the base R₁. The audio presentation device 204 is an example of the presentation device.

The return audio recording device 205 is a device including a microphone that records an audio of the base R₁. For example, the return audio recording device 205 records an audio of a state of the base R₁ where the audio presentation device 204 that reproduces and outputs an audio transmitted from the base O to the base R₁ is installed. The return audio recording device 205 is an example of the audio recording device.

A configuration example of the server 2 will be described.

The server 2 includes a control unit 21, a program storage unit 22, a data storage unit 23, a communication interface 24, and an input/output interface 25. The elements included in the server 2 are connected to each other via a bus.

The control unit 21 can be formed similarly to the control unit 11. A processor deploys a ROM or a program stored in the program storage unit 22 in a RAM. The processor executes a program deployed in the RAM, thereby the control unit 21 implements each functional unit described below. The control unit 21 is included in a computer.

The program storage unit 22 can be formed similarly to the program storage unit 12.

The data storage unit 23 can be formed similarly to the data storage unit 13.

The communication interface 24 can be formed similarly to the communication interface 14. The communication interface 14 includes various interfaces that communicatively connect the server 2 to other electronic devices.

The input/output interface 25 can be formed similarly to the input/output interface 15. The input/output interface 25 enables communication between the server 2 and each of the video presentation device 201, the offset video capturing device 202, the return video capturing device 203, the audio presentation device 204, and the return audio recording device 205.

Note that a hardware configuration of the server 2 is not limited to the above-described configuration. The server 2 can appropriately omit and change the above-described components and add a new component.

Since hardware configurations of a plurality of electronic devices included in each of bases R₂ to Rₙ are similar to those of the base R₁ described above, description thereof will be omitted.

The time distribution server 10 is an electronic device that manages a reference system clock. The reference system clock is an absolute time.

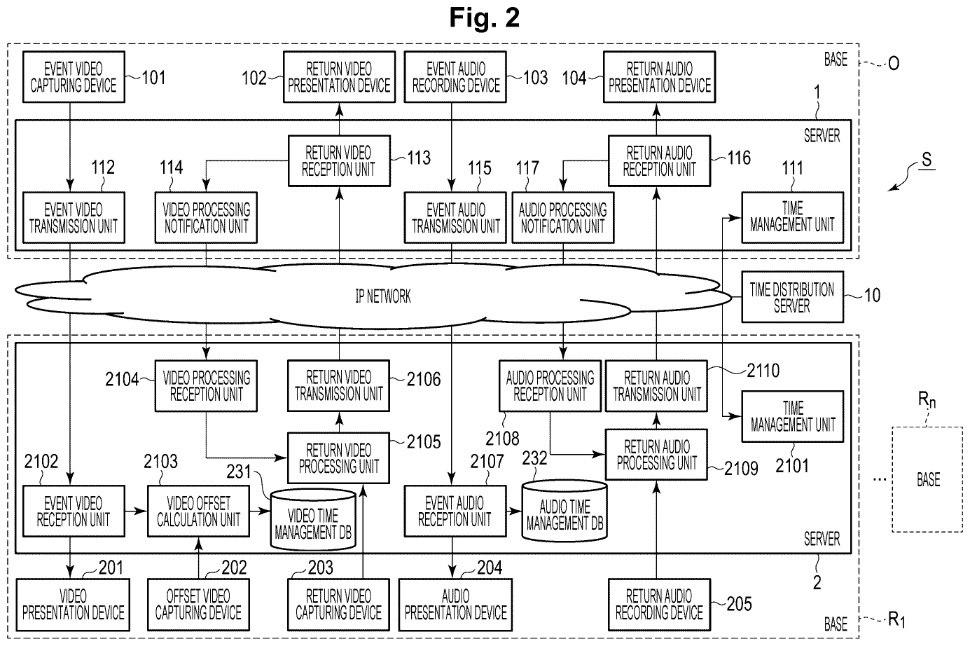

FIG. 2 is a block diagram illustrating an example of a software configuration of each of the electronic devices included in the medium processing system S according to the first embodiment.

The server 1 includes a time management unit 111, an event video transmission unit 112, a return video reception unit 113, a video processing notification unit 114, an event audio transmission unit 115, a return audio reception unit 116, and an audio processing notification unit 117. Each functional unit is implemented by execution of a program by the control unit 11. It can also be said that each functional unit is included in the control unit 11 or the processor. Each functional unit can be read as the control unit 11 or the processor.

The time management unit 111 performs time synchronization with the time distribution server 10 using a known protocol such as NTP or PTP, and manages the reference system clock. The time management unit 111 manages the same reference system clock as the reference system clock managed by the server 2. The reference system clock managed by the time management unit 111 and the reference system clock managed by the server 2 are time-synchronized.

The event video transmission unit 112 transmits an RTP packet that stores a video V_{signal} output from the event video capturing device 101 to each of servers of the bases R₁ to Rₙ via the IP network. The video V_{signal1} is a video acquired at a time T_{video} that is an absolute time in the base O. Acquiring the video V_{signal1} includes capturing the video V_{signal1} by the event video capturing device 101. Acquiring the video V_{signal1} includes sampling the video V_{signal1} obtained by capturing by the event video capturing device 101. A time T_{video} is provided to the RTP packet that stores the video V_{signal1}. The time T_{video} is a time at which the video V_{signal1} is acquired in the base O. The video V_{signal1} is an example of a first video. The time T_{video} is an example of a first time. The RTP packet is an example of a packet.

The return video reception unit 113 receives an RTP packet that stores a video V_{signal3} generated from a video V_{signal2} from each of the servers of the bases R₁ to Rₙ via the IP network. The video V_{signal2} is a video acquired in any one of the bases R₁ to Rₙ at a time at which the video V_{signal1} is reproduced in this base. Acquiring the video V_{signal2} includes capturing the video V_{signal2} by the return video capturing device 203. Acquiring the video V_{signal2} includes sampling the video V_{signal2} obtained by capturing by the return video capturing device 203. The video V_{signal2} is an example of a second video. The video V_{signal3} is a video generated from the video V_{signal2} by each of the servers of the bases R₁ to Rₙ according to a processing mode based on Δd_{x_video}. The video V_{signal3} is an example of a third video. The time T_{video} is provided to the RTP packet that stores the video V_{signal3}. Since the video V_{signal3} is generated from the video V_{signal2}, the RTP packet that stores the video V_{signal3} is an example of a packet regarding the video V_{signal2}. The Δd_{x_video} is a value regarding a data transmission delay between the base O and each of the bases R₁ to Rₙ. The Δd_{x_video} is an example of a transmission delay time. The Δd_{x_video} is different in each of the bases R₁ to Rₙ.

The video processing notification unit 114 generates the Δd_{x_video} for each of the bases R₁ to Rₙ, and transmits an RTCP packet that stores the Δd_{x_video} to each of the servers of the bases R₁ to Rₙ. The RTCP packet that stores the Δd_{x_video} is an example of notification regarding the transmission delay time. The RTCP packet is an example of a packet.

The event audio transmission unit 115 transmits an RTP packet that stores an audio A_{signal1} output from the event audio recording device 103 to each of the servers of the bases R₁ to Rₙ via the IP network. The audio A_{signal1} is an audio acquired at a time T_{audio} that is an absolute time in the base O. Acquiring the audio A_{signal1} includes recording the audio A_{signal1} by the event audio recording device 103. Acquiring the audio A_{signal1} includes sampling the audio A_{signal1} obtained by recording by the event audio recording device 103. The time T_{audio} is provided to the RTP packet that stores the audio A_{signal1}. The time T_{audio} is a time at which the audio A_{signal1} is acquired in the base O. The audio A_{signal1} is an example of a first audio. The time T_{audio} is an example of the first time.

The return audio reception unit 116 receives an RTP packet that stores an audio A_{signal3} generated from an audio A_{signal2} from each of the servers of the bases R₁ to Rₙ via the IP network. The audio A_{signal2} is an audio acquired in any one of the bases R₁ to Rₙ at a time at which the audio A_{signal1} is reproduced in this base. Acquiring the audio A_{signal1} includes recording the audio A_{signal2} by the return audio recording device 205. Acquiring the audio A_{signal2} includes sampling the audio A_{signal2} obtained by recording by the return audio recording device 205. The audio A_{signal2} is an example of a second audio. The audio A_{signal3} is an audio generated from the audio A_{signal2} by each of the servers of the bases R₁ to Rₙ according to a processing mode based on Δd_{x_audio}. The audio A_{signal3} is an example of a third audio. The time T_{audio} is provided to the RTP packet that stores the audio A_{signal3}. Since the audio A_{signal3} is generated from the audio A_{signal2}, the RTP packet that stores the audio A_{signal3} is an example of a packet regarding the audio A_{signal2}. The Δd_{x_audio}, is a value regarding a data transmission delay between the base O and each of the bases R₁ to Rₙ. The Δd_{x_audio} is an example of a transmission delay time. The Δd_{x_audio} is different in each of the bases R₁ to Rₙ.

The audio processing notification unit 117 generates the Δd_{x_audio} for each of the bases R₁ to Rₙ, and transmits an RTCP packet that stores the Δd_{x_audio} to each of the servers of the bases R₁ to Rₙ. The RTCP packet that stores the Δd_{x_audio} is an example of notification regarding the transmission delay time.

The server 2 includes a time management unit 2101, an event video reception unit 2102, a video offset calculation unit 2103, a video processing reception unit 2104, a return video processing unit 2105, a return video transmission unit 2106, an event audio reception unit 2107, an audio processing reception unit 2108, a return audio processing unit 2109, a return audio transmission unit 2110, a video time management DB 231, and an audio time management DB 232. Each functional unit is implemented by execution of a program by the control unit 21. It can also be said that each functional unit is included in the control unit 21 or a processor. Each functional unit can be read as the control unit 21 or the processor. The video time management DB 231 and the audio time management DB 232 are implemented by the data storage unit 23.

The time management unit 2101 performs time synchronization with the time distribution server 10 using a known protocol such as NTP or PTP, and manages the reference system clock. The time management unit 2101 manages the same reference system clock as the reference system clock managed by the server 1. The reference system clock managed by the time management unit 2101 and the reference system clock managed by the server 1 are time-synchronized.

The event video reception unit 2102 receives an RTP packet that stores a video V_{signal1} from the server 1 via the IP network. The event video reception unit 2102 outputs the video V_{signal1} to the video presentation device 201. The event video reception unit 2102 is an example of a second reception unit.

The video offset calculation unit 2103 calculates a presentation time t₁ that is an absolute time at which the video V_{signal1} is reproduced by the video presentation device 201. The video offset calculation unit 2103 is an example of a calculation unit.

The video processing reception unit 2104 receives an RTCP packet that stores Δd_{x_video} from the server 1. The video processing reception unit 2104 is an example of a first reception unit.

The return video processing unit 2105 generates a video V_{signal3} from a video V_{signal2} according to a processing mode based on the Δd_{x_video}. The return video processing unit 2105 is an example of a processing unit.

The return video transmission unit 2106 transmits an RTP packet that stores the video V_{signal3} to the server 1 via the IP network. The RTP packet that stores the video V_{signal3} includes a time T_{video} associated with the presentation time t₁ that matches a time t that is an absolute time at which the video V_{signal2} is obtained by capturing. The return video transmission unit 2106 is an example of a transmission unit.

The event audio reception unit 2107 receives an RTP packet that stores an audio A_{signal1} from the server 1 via the IP network. The event audio reception unit 2107 outputs the audio A_{signal1} to the audio presentation device 204. The event audio reception unit 2107 is an example of the second reception unit.

The audio processing reception unit 2108 receives an RTCP packet that stores Δd_{x_audio} from the server 1. The audio processing reception unit 2108 is an example of the first reception unit.

The return audio processing unit 2109 generates an audio A_{signal3} from an audio A_{signal2} according to a processing mode based on the Δd_{x_audio}. The return audio processing unit 2109 is an example of the processing unit.

The return audio transmission unit 2110 transmits an RTP packet that stores the audio A_{signal3} to the server 1 via the IP network. The RTP packet that stores the audio A_{signal3} includes a time T_{audio}. The return audio transmission unit 2110 is an example of the transmission unit.

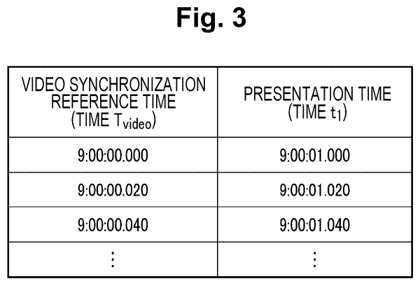

FIG. 3 is a diagram illustrating an example of a data structure of the video time management DB 231 included in the server 2 of the base R₁ according to the first embodiment.

The video time management DB 231 is a DB that stores times T_{video} acquired from the video offset calculation unit 2103 and presentation times t₁ in association with each other.

The video time management DB 231 includes a video synchronization reference time column and a presentation time column. The video synchronization reference time column stores the times T_{video}. The presentation time column stores the presentation times t₁.

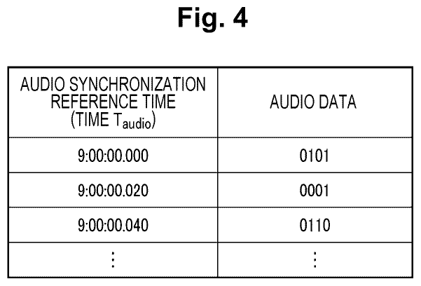

FIG. 4 is a diagram illustrating an example of a data structure of the audio time management DB 232 included in the server 2 of the base R₁ according to the first embodiment.

The audio time management DB 232 is a DB that stores times T acquired from the event audio reception unit 2107 and audios A_{signal1} in association with each other.

The audio time management DB 232 includes an audio synchronization reference time column and an audio data column. The audio synchronization reference time column stores the times T_{audio}. The audio data column stores the audios A_{signal1}.

Each of the servers of the bases R₂ to Rₙ includes functional units and a DB similar to those of the server 1 of the base R₁, and performs processing similar to that of the server 1 of the base R₁. Description of a processing flow and a DB structure of the functional units included in each of the servers of the bases R₂ to Rₙ will be omitted.

### Operation Example

Hereinafter, operation of the base O and the base R₁ will be described as an example. Operation of the bases R₂ to Rₙ may be similar to operation of the base R₁, and description thereof will be omitted. The notation of the base R₁ may be read as the bases R₂ to Rₙ.

### (1) Process and Reproduce Return Video

Video processing of the server 1 in the base O will be described.

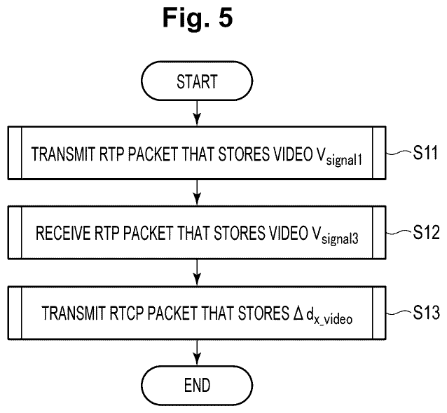

FIG. 5 is a flowchart illustrating a video processing procedure and processing content of the server 1 in the base O according to the first embodiment.

The event video transmission unit 112 transmits an RTP packet that stores a video V_{signal1} to the server 2 of the base R₁ via the IP network (step S11). A typical example of processing of step S11 will be described below.

The return video reception unit 113 receives an RTP packet that stores a video V_{signal3} from the server 2 of the base R₁ via the IP network (step S12). A typical example of processing of step S12 will be described below.

The video processing notification unit 114 generates Δd_{x_video} for the base R₁, and transmits an RTCP packet that stores the Δd_{x_video} to the server 2 of the base R₁. (step S13). A typical example of processing of step S13 will be described below.

Video processing of the server 2 in the base R₁ will be described.

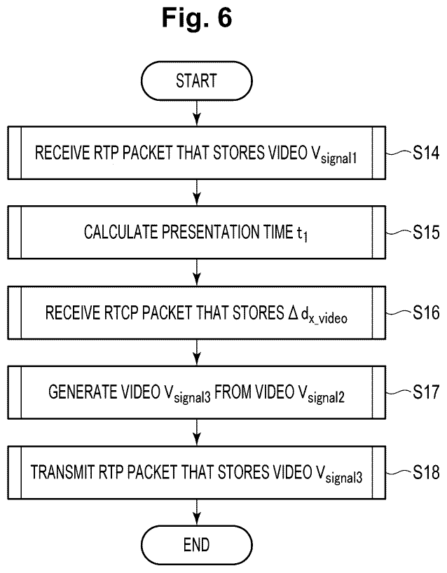

FIG. 6 is a flowchart illustrating a video processing procedure and processing content of the server 2 in the base R₁ according to the first embodiment.

The event video reception unit 2102 receives an RTP packet that stores a video V_{signal1} from the server 1 via the IP network (step S14). A typical example of processing of step S14 will be described below.

The video offset calculation unit 2103 calculates a presentation time t₁ at which the video V_{signal1} is reproduced by the video presentation device 201 (step S15). A typical example of processing of step S15 will be described below.

The video processing reception unit 2104 receives an RTCP packet that stores Δd_{x_video} from the server 1 (step S16). A typical example of processing of step S16 will be described below.

The return video processing unit 2105 generates a video V_{signal1} from a video V_{signal2} according to a processing mode based on the Δd_{x_video} (step S17). A typical example of processing of step S17 will be described below.

The return video transmission unit 2106 transmits an RTP packet that stores a video V_{signal3} to the server 1 via the IP network (step S18). A typical example of processing of step S18 will be described below.

Hereinafter, typical examples of processing of steps S11 to S13 of the server 1 described above and processing of steps S14 to S18 of the server 2 described above will be described. In order of the processing in chronological order, the processing in step S11 of the server 1, the processing in step S14 of the server 2, the processing in step S15 of the server 2, the processing in step S12 of the server 1, the processing in step S13 of the server 1, the processing in step S16 of the server 2, the processing in step S17 of the server 2, and the processing in step S18 of the server 2 will be described in this order.

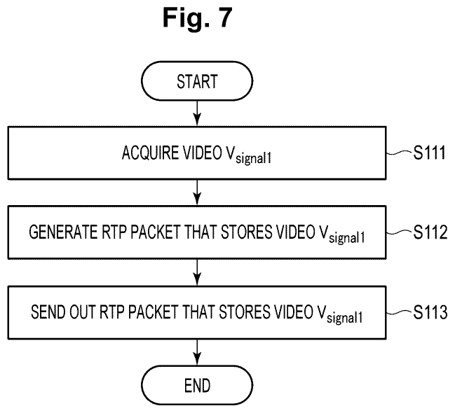

FIG. 7 is a flowchart illustrating a transmission processing procedure and processing content of an RTP packet that stores a video V_{signal1} of the server 1 in the base O according to the first embodiment. FIG. 7 illustrates the typical example of the processing of step S11.

The event video transmission unit 112 acquires a video V_{signal1} output from the event video capturing device 101 at constant intervals I_{video} (step S111).

The event video transmission unit 112 generates an RTP packet that stores the video V_{signal1} (step S112). In step S112, for example, the event video transmission unit 112 stores the acquired video V_{signal1} in an RTP packet. The event video transmission unit 112 acquires a time T_{video} that is an absolute time at which the video V_{signal1} is sampled from the reference system clock managed by the time management unit 111. The event video transmission unit 112 stores the acquired time T_{video} in the header extension area of the RTP packet.

The event video transmission unit 112 sends out the generated RTP packet that stores the video V_{signal1} to the IP network (step S113).

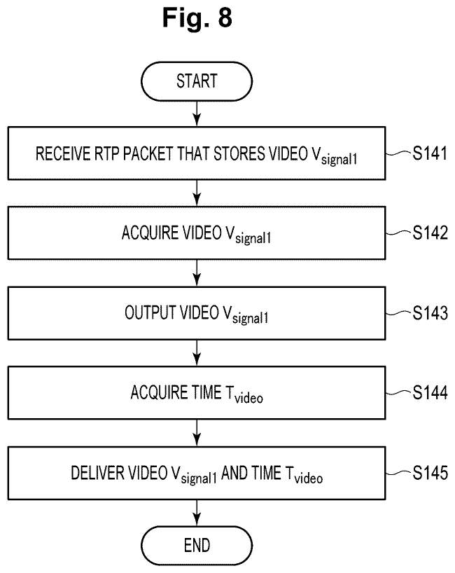

FIG. 8 is a flowchart illustrating a reception processing procedure and processing content of an RTP packet that stores a video V_{signal1} of the server 2 in the base R₁ according to the first embodiment. FIG. 8 illustrates the typical example of the processing of step S14 of the server 2.

The event video reception unit 2102 receives an RTP packet that stores a video V_{signal1} sent out from the event video transmission unit 112 via the IP network (step S141).

The event video reception unit 2102 acquires the video V_{signal1} stored in the received RTP packet that stores the video V_{signal1} (step S142).

The event video reception unit 2102 outputs the acquired video V_{signal1} to the video presentation device 201 (step S143). The video presentation device 201 reproduces and displays the video V_{signal1}.

The event video reception unit 2102 acquires a time T_{video} stored in the header extension area of the received RTP packet that stores the video V_{signal1} (step S144).

The event video reception unit 2102 delivers the acquired video V_{signal1} and time T_{video} to the video offset calculation unit 2103 (step S145).

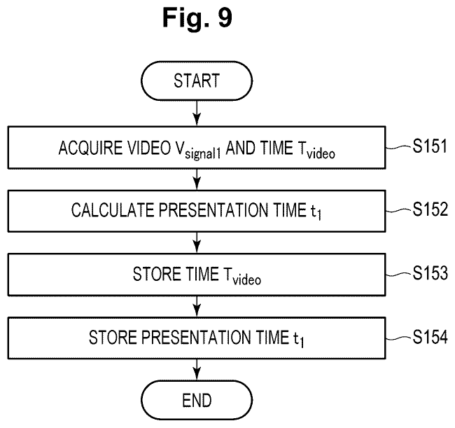

FIG. 9 is a flowchart illustrating a calculation processing procedure and processing content of a presentation time t₁ of the server 2 in the base R₁ according to the first embodiment. FIG. 9 illustrates the typical example of the processing of step S15 of the server 2.

The video offset calculation unit 2103 acquires a video V_{signal1} and a time T_{video} from the event video reception unit 2102 (step S151).

The video offset calculation unit 2103 calculates a presentation time t₁ on the basis of the acquired video V_{signal1} and a video input from the offset video capturing device 202 (step S152). In step S152, for example, the video offset calculation unit 2103 extracts a video frame including the video V_{signal1} from the video obtained by capturing by the offset video capturing device 202 using a known image processing technology. The video offset calculation unit 2103 acquires a capturing time provided to the extracted video frame as the presentation time t₁. The capturing time is an absolute time.

The video offset calculation unit 2103 stores the acquired time T_{video} in the video synchronization reference time column of the video time management DB 231 (step S153).

The video offset calculation unit 2103 stores the acquired presentation time t₁ in the presentation time column of the video time management DB 231 (step S154).

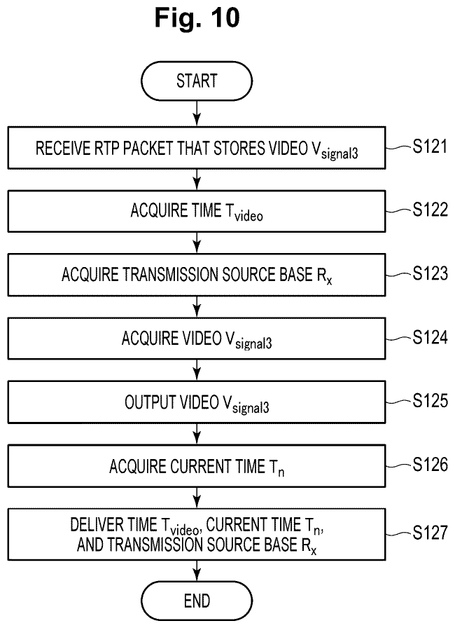

FIG. 10 is a flowchart illustrating a reception processing procedure and processing content of an RTP packet that stores a video V_{signal3} of the server 1 in the base O according to the first embodiment. FIG. 10 illustrates the typical example of the processing of step S12 of the server 1.

The return video reception unit 113 receives an RTP packet that stores a video V_{signal3} sent out from the return video transmission unit 2106 via the IP network (step S121).

The return video reception unit 113 acquires a time T_{video} stored in the header extension area of the received RTP packet that stores the video V_{signal3} (step S122).

The return video reception unit 113 acquires a transmission source base Rₓ (x is any one of 1, 2, . . . , and n) from information stored in the header of the received RTP packet that stores the video V_{signal3} (step S123).

The return video reception unit 113 acquires the video V_{signal3} stored in the received RTP packet that stores the video V_{signal3} (step S124).

The return video reception unit 113 outputs the video V_{signal3} to the return video presentation device 102 (step S125). In step S125, for example, the return video reception unit 113 outputs the video V_{signal3} to the return video presentation device 102 at the constant interval I_{video}. The return video presentation device 102 reproduces and displays the video V_{signal3} returned and transmitted from the base R₁ to the base O.

The return video reception unit 113 acquires a current time Tₙ from the reference system clock managed by the time management unit 111 (step S126). The current time Tₙ is a time associated with reception of the RTP packet that stores the video V_{signal3} by the return video reception unit 113. The current time Tₙ can also be referred to as a reception time of the RTP packet that stores the video V_{signal3}. The current time Tₙ can also be referred to as a reproduction time of the video V_{signal3}. The current time Tₙ associated with the reception of the RTP packet that stores the video V_{signal3} is an example of a second time.

The return video reception unit 113 delivers the acquired time T_{video}, current time Tₙ, and transmission source base Rₓ to the video processing notification unit 114 (step S127).

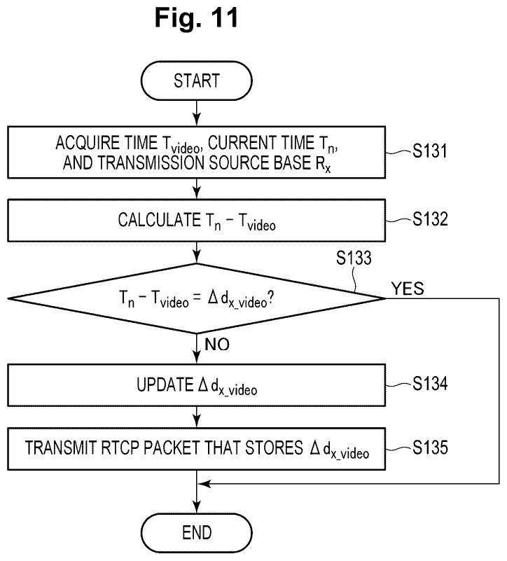

FIG. 11 is a flowchart illustrating a transmission processing procedure and processing content of an RTCP packet that stores Δd_{x_video} of the server 1 in the base O according to the first embodiment. FIG. 11 illustrates the typical example of the processing of step S13 of the server 1.

The video processing notification unit 114 acquires a time T_{video}, a current time Tₙ, and a transmission source base Rₓ from the return video reception unit 113 (step S131).

The video processing notification unit 114 calculates a time (Tₙ−T_{video}) obtained by subtracting the time T_{video} from the current time Tₙ on the basis of the time T_{video} and the current time Tₙ (step S132).

The video processing notification unit 114 determines whether the time (Tₙ−T_{video}) matches current Δd_{x_video} (step S133). The Δd_{x_video} is a value of a difference between the current time Tₙ and the time T_{video}. The current Δd_{x_video} is a value of a time (Tₙ−T_{video}) calculated before a value of the time (Tₙ−T_{video}) calculated this time. An initial value of the Δd_{x_video} is set to 0. In a case where the time (Tₙ−T_{video}) matches the current Δd_{x_video} (YES in step S133), the processing ends. In a case where the time (Tₙ−T_{video}) does not match the current Δd_{x_video} (NO in step S133), the processing proceeds from step S133 to step S134. The time (Tₙ−T_{video}) not matching the current Δd_{x_video} corresponds to the Δd_{x_video} having changed.

The video processing notification unit 114 updates the Δd_{x_video} to Δd_{x_video}=Tₙ−T_{video} (step S134).

The video processing notification unit 114 transmits an RTCP packet that stores the Δd_{x_video} (step S135). In step S135, for example, the video processing notification unit 114 describes the updated Δd_{x_video} using an APP in the RTCP. The video processing notification unit 114 generates the RTCP packet that stores the Δd_{x_video}. The video processing notification unit 114 transmits the RTCP packet that stores the Δd_{x_video} to a base indicated by the acquired transmission source base Rₓ.

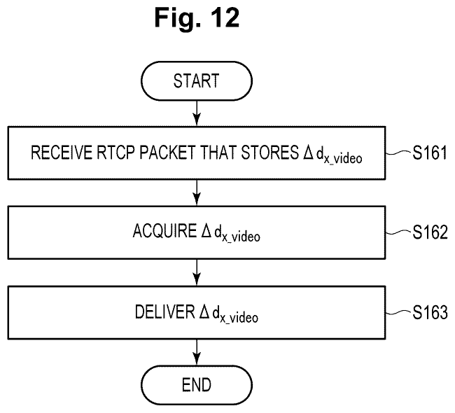

FIG. 12 is a flowchart illustrating a reception processing procedure and processing content of an RTCP packet that stores Δd_{x_video} of the server 2 in the base R₁ according to the first embodiment. FIG. 12 illustrates the typical example of the processing of step S16 of the server 2.

The video processing reception unit 2104 receives an RTCP packet that stores Δd_{x_video} from the server 1 (step S161).

The video processing reception unit 2104 acquires the Δd_{x_video} stored in the RTCP packet that stores the Δd_{x_video} (step S162).

The video processing reception unit 2104 delivers the acquired Δd_{x_video} to the return video processing unit 2105 (step S163).

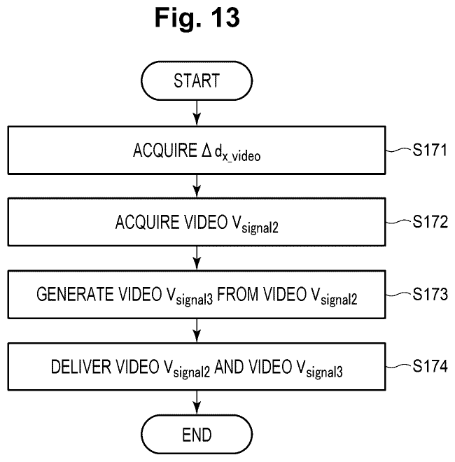

FIG. 13 is a flowchart illustrating a process processing procedure and processing content of a video V_{signal2} of the server 2 in the base R₁ according to the first embodiment. FIG. 13 illustrates the typical example of the processing of step S17 of the server 2.

The return video processing unit 2105 acquires Δd_{x_video} from the video processing reception unit 2104 (step S171).

The return video processing unit 2105 acquires a video V_{signal2} output from the return video capturing device 203 at the constant intervals I_{video} (step S172). The video V_{signal2} is a video acquired in the base R₁ at a time at which the video presentation device 201 reproduces a video V_{signal1} in the base R₁.

The return video processing unit 2105 generates a video V_{signal3} from the acquired video V_{signal2} according to a processing mode based on the acquired Δd_{x_video} (step S173). In step S173, for example, the return video processing unit 2105 determines the processing mode of the video V_{signal2} on the basis of the Δd_{x_video}. The return video processing unit 2105 changes the processing mode of the video V_{signal2} on the basis of the Δd_{x_video}. The return video processing unit 2105 changes the processing mode so as to lower the quality of the video as the Δd_{x_video} increases. The processing mode may include both performing processing on the video V_{signal2} and not performing processing on the video V_{signal2}. The processing mode includes a degree of processing on the video V_{signal2}. In a case where the return video processing unit 2105 performs processing on the video V_{signal2}, the video V_{signal3} is different from the video V_{signal2}. In a case where the return video processing unit 2105 does not perform processing on the video V_{signal2}, the video V_{signal3} is the same as the video V_{signal2}.

The return video processing unit 2105 performs processing of reducing the visibility on the basis of the Δd_{x_video} when reproduction is performed by the return video presentation device 102 of the base O. The processing of reducing the visibility includes processing of reducing the data size of the video. When the Δd_{x_video} is so small that viewers do not feel discomfort by reproduction of the video V_{signal2} by the return video presentation device 102, the return video processing unit 2105 does not perform processing on the video V_{signal2}. Furthermore, even in a case where the Δd_{x_video} is too large, the return video processing unit 2105 performs processing on the video V_{signal2} so that the video does not become completely visually unrecognizable. For example, a case of processing of changing the display size of the video V_{signal2} will be described. Assuming that a horizontal pixel of the video V_{signal2} is w and a vertical pixel is h, a horizontal pixel w′ and a vertical pixel h′ of the video V_{signal3} generated according to the processing mode are as follows.
(1) When 0 ms≤Δd_{x_video}≤300 ms,

$${w}^{′} = w , {h}^{′} = h$$

(2) When 300 ms<Δd_{x_video}≤500 ms,

$${w}^{′} = \{ - ( 1 / 400 ) * Δ {d}_{x \_ video} + 7 / 4 \} * w , {h}^{′} = \{ - ( 1 / 400 ) * Δ {d}_{x \_ video} + 7 / 4 \} * h$$

(3) When 500 ms<Δd_{x_video},

$${w}^{′} = 0.5 * w , {h}^{′} = 0.5 h$$

The processing is not limited to the above as the change of the quality of the video, and may be, in addition to the above display size change, blurring an image by a Gaussian filter, lowering the luminance of an image, or the like. The processing may use other processing as long as the processed video V_{signal3} has lower visibility than the video V_{signal2}.

The return video processing unit 2105 delivers the acquired video V_{signal2} and the generated video V_{signal3} to the return video transmission unit 2106 (step S174).

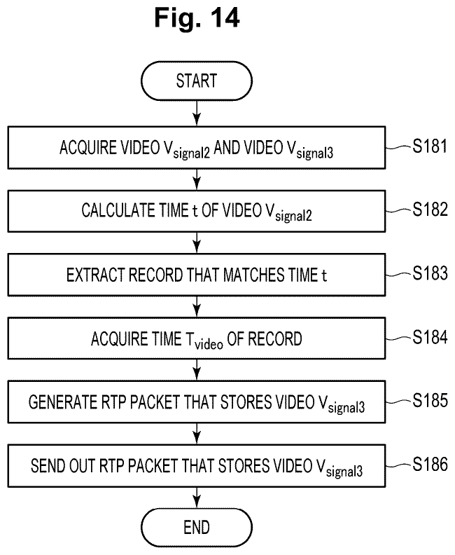

FIG. 14 is a flowchart illustrating a transmission processing procedure and processing content of an RTP packet that stores a video V_{signal3} of the server 2 in the base R₁ according to the first embodiment. FIG. 14 illustrates the typical example of the processing of step S18 of the server 2.

The return video transmission unit 2106 acquires a video V_{signal2} and a video V_{signal3} from the return video processing unit 2105 (step S181). In step S181, for example, the return video transmission unit 2106 simultaneously acquires a video V_{signal2} and a video V_{signal3} at the constant intervals I_{video}.

The return video transmission unit 2106 calculates a time t that is an absolute time at which the acquired video V_{signal2} is obtained by capturing (step S182). In step S182, for example, in a case where a time code T_{c} (absolute time) representing a capturing time is provided to the video V_{signal2}, the return video transmission unit 2106 acquires the time t as t=T_{c}. In a case where the time code T_{c} is not provided to the video V_{signal2}, the return video transmission unit 2106 acquires a current time Tₙ from the reference system clock managed by the time management unit 2101. The return video transmission unit 2106 acquires the time t as t=Tₙ−t_{video_offset} using a predetermined value t_{video_offset} (positive number).

The return video transmission unit 2106 refers to the video time management DB 231 and extracts a record having a time t₁ that matches the acquired time t (step S183).

The return video transmission unit 2106 refers to the video time management DB 231 and acquires a time T_{video} in the video synchronization reference time column of the extracted record (step S184).

The return video transmission unit 2106 generates an RTP packet that stores the video V_{signal3} (step S185). In step S185, for example, the return video transmission unit 2106 stores the acquired video V_{signal3} in an RTP packet. The return video transmission unit 2106 stores the acquired time T_{video} in the header extension area of the RTP packet.

The return video transmission unit 2106 sends out the generated RTP packet that stores the video V_{signal3} to the IP network (step S186).

### (2) Process and Reproduce Return Audio

Audio processing of the server 1 in the base O will be described.

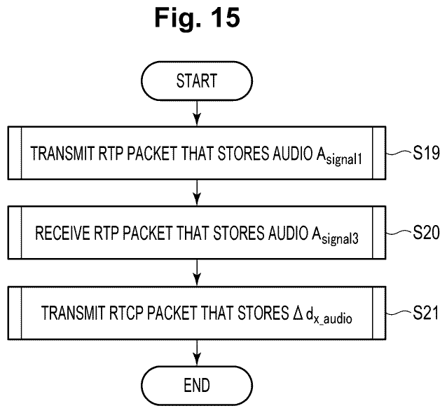

FIG. 15 is a flowchart illustrating an audio processing procedure and processing content of the server 1 in the base O according to the first embodiment.

The event audio transmission unit 115 transmits an RTP packet that stores an audio A_{signal1} to the server 2 of the base R₁ via the IP network (step S19). A typical example of processing of step S19 will be described below.

The return audio reception unit 116 receives an RTP packet that stores an audio A_{signal3} from the server 2 of the base R₁ via the IP network (step S20). A typical example of processing of step S20 will be described below.

The audio processing notification unit 117 generates Δd_{x_video} for the base R₁, and transmits an RTCP packet that stores the Δd_{x_audio} to the server 2 of the base R₁. (step S21). A typical example of processing of step S21 will be described below.

Audio processing of the server 2 in the base R₁ will be described.

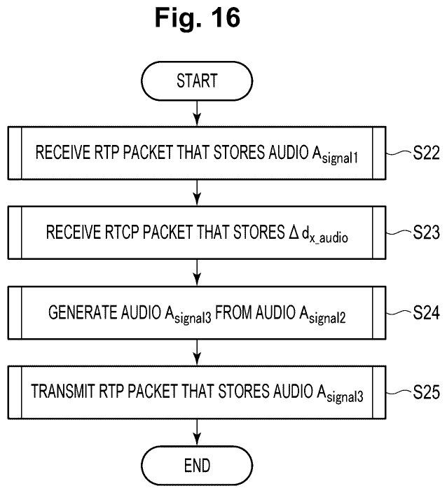

FIG. 16 is a flowchart illustrating an audio processing procedure and processing content of the server 2 in the base R₁ according to the first embodiment.

The event audio reception unit 2107 receives an RTP packet that stores an audio A_{signal1} a from the server 1 via the IP network (step S22). A typical example of processing of step S22 will be described below.

The audio processing reception unit 2108 receives an RTCP packet that stores Δd_{x_audio} from the server 1 (step S23). A typical example of processing of step S23 will be described below.

The return audio processing unit 2109 generates an audio A_{signal3} from an audio A_{signal2} according to a processing mode based on the Δd_{x_audio} (step S24). A typical example of processing of step S24 will be described below.

The return audio transmission unit 2110 transmits an RTP packet that stores the audio A_{signal3} to the server 1 via the IP network (step S25). A typical example of processing of step S25 will be described below.

Hereinafter, typical examples of processing of steps S19 to S21 of the server 1 described above and processing of steps S22 to S25 of the server 2 described above will be described. In order of the processing in chronological order, the processing in step S19 of the server 1, the processing in step S22 of the server 2, the processing in step S20 of the server 1, the processing in step S21 of the server 1, the processing in step S23 of the server 2, the processing in step S24 of the server 1, and the processing in step S25 of the server 1 will be described in this order.

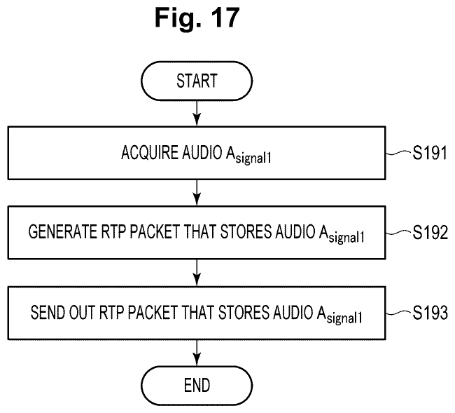

FIG. 17 is a flowchart illustrating a transmission processing procedure and processing content of an RTP packet that stores an audio A_{signal1} of the server 1 in the base O according to the first embodiment. FIG. 17 illustrates the typical example of the processing of step S19 of the server 1.

The event audio transmission unit 115 acquires an audio A_{signal1} an output from the event audio recording device 103 at constant intervals I_{audio} (step S191).

The event audio transmission unit 115 generates an RTP packet that stores the audio A_{signal1} (step S192). In step S192, for example, the event audio transmission unit 115 stores the acquired audio A_{signal1} in an RTP packet. The event audio transmission unit 115 acquires a time T_{audio} that is an absolute time at which the audio A_{signal1} is sampled from the reference system clock managed by the time management unit 111. The event audio transmission unit 115 stores the acquired time T_{audio} in the header extension area of the RTP packet.

The event audio transmission unit 115 sends out the generated RTP packet that stores the audio A_{signal1} to the IP network (step S193).

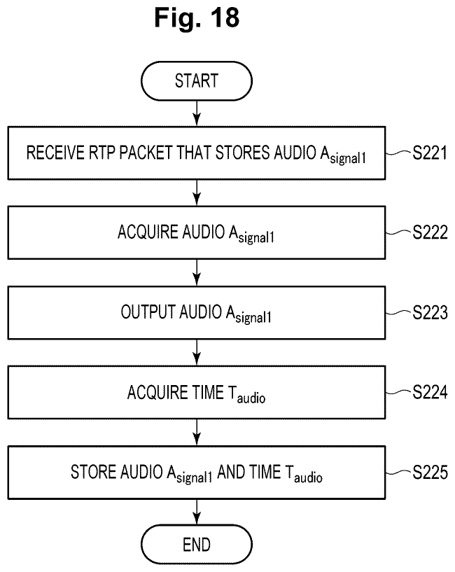

FIG. 18 is a flowchart illustrating a reception processing procedure and processing content of an RTP packet that stores an audio A_{signal1} of the server 2 in the base R₁ according to the first embodiment. FIG. 18 illustrates the typical example of the processing of step S22 of the server 2.

The event audio reception unit 2107 receives an RTP packet that stores an audio A_{signal1} sent out from the event audio transmission unit 115 via the IP network (step S221).

The event audio reception unit 2107 acquires the audio A_{signal1} stored in the received RTP packet that stores the audio A_{signal1} (step S222)

The event audio reception unit 2107 outputs the acquired audio A_{signal1} to the audio presentation device 204 (step S223). The audio presentation device 204 reproduces and outputs the audio A_{signal1}.

The event audio reception unit 2107 acquires a time T_{audio} stored in the header extension area of the received RTP packet that stores the audio A_{signal1} (step S224).

The event audio reception unit 2107 stores the acquired audio A_{signal1} and time T_{audio} in the audio time management DB 232 (step S225). In step S225, for example, the event audio reception unit 2107 stores the acquired time T_{audio} in the audio synchronization reference time column of the audio time management DB 232. The event audio reception unit 2107 stores the acquired audio A_{signal1} in the audio data column of the audio time management DB 232.

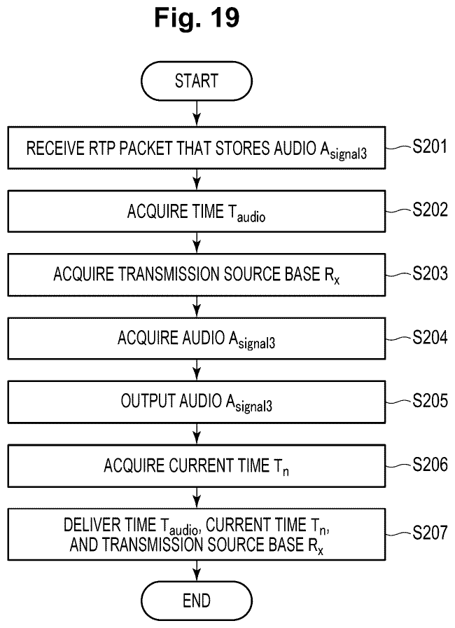

FIG. 19 is a flowchart illustrating a reception processing procedure and processing content of an RTP packet that stores an audio A_{signal3} of the server 1 in the base O according to the first embodiment. FIG. 19 illustrates the typical example of the processing of step S20 of the server 1.

The return audio reception unit 116 receives an RTP packet that stores an audio A_{signal3} sent out from the return audio transmission unit 2110 via the IP network (step S201).

The return audio reception unit 116 acquires a time T_{audio} stored in the header extension area of the received RTP packet that stores the audio A_{signal3} (step S202).

The return audio reception unit 116 acquires a transmission source base Rₓ (x is any one of 1, 2, . . . , and n) from information stored in the header of the received RTP packet that stores the audio A_{signal3} (step S203).

The return audio reception unit 116 acquires the audio A_{signal3} stored in the received RTP packet that stores the audio A_{signal3} (step S204).

The return audio reception unit 116 outputs the audio A_{signal3} to the return audio presentation device 104 (step S205). In step S205, for example, the return audio reception unit 116 outputs the audio A_{signal3} to the return audio presentation device 104 at the constant intervals I_{audio}. The return audio presentation device 104 reproduces and displays the audio A_{signal3} returned and transmitted from the base R₁ to the base O.

The return audio reception unit 116 acquires a current time Tₙ from the reference system clock managed by the time management unit 111 (step S206). The current time Tₙ is a time associated with reception of the RTP packet that stores the audio A_{signal3} by the return audio reception unit 116. The current time Tₙ can also be referred to as a reception time of the RTP packet that stores the audio A_{signal3}. The current time Tₙ can also be referred to as a reproduction time of the audio A_{signal3}. The current time Tₙ associated with the reception of the RTP packet that stores the audio A_{signal3} is an example of the second time.

The return audio reception unit 116 delivers the acquired time T_{audio}, current time Tₙ, and transmission source base Rₓ to the audio processing notification unit 117 (step S207).

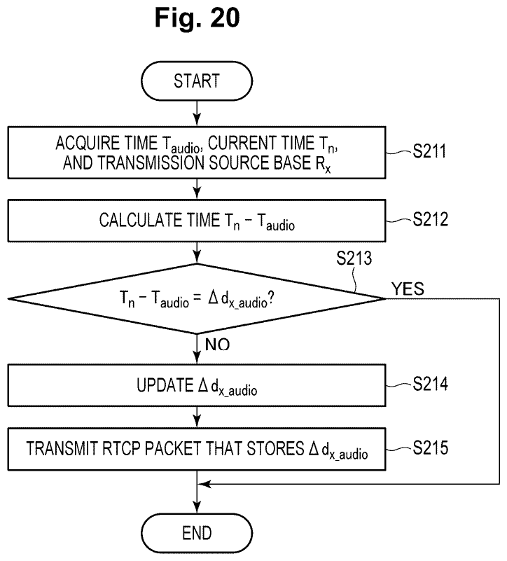

FIG. 20 is a flowchart illustrating a transmission processing procedure and processing content of an RTCP packet that stores Δd_{x_audio} of the server 1 in the base O according to the first embodiment. FIG. 20 illustrates the typical example of the processing of step S21 of the server 1.

The audio processing notification unit 117 acquires a time T_{audio}, a current time Tₙ, and a transmission source base Rₓ from the return audio reception unit 116 (step S211).

The audio processing notification unit 117 calculates a time (Tₙ−T_{audio}) obtained by subtracting the time T_{audio} from the current time Tₙ on the basis of the time T_{audio} and the current time Tₙ (step S212).

The audio processing notification unit 117 determines whether the time (Tₙ, −T_{audio}) matches current Δd_{x_audio} (step S213). The Δd_{x_audio} is a value of a difference between the current time Tₙ and the time T_{audio}. The current Δd_{x_audio} is a value of a time (Tₙ−T_{audio}) calculated before a value of the time (Tₙ−T_{audio}) calculated this time. An initial value of the Δd_{x_audio} is set to 0. In a case where the time (Tₙ−T_{audio}) matches the current Δd_{x_audio} (YES in step S213), the processing ends. In a case where the time (Tₙ−T_{audio}) does not match the current Δd_{x_audio} (NO in step S213), the processing proceeds from step S213 to step S214. The time (Tₙ−T_{audio}) not matching the current Δd_{x_audio} corresponds to the Δd_{x_audio} having changed.

The audio processing notification unit 117 updates the Δd_{x_audio} to Δd_{x_audio}=Tₙ−T_{audio} (step S214).

The audio processing notification unit 117 transmits an RTCP packet that stores the Δd_{x_audio} (step S215). In step S215, for example, the audio processing notification unit 117 describes the updated Δd_{x_audio} using an APP in the RTCP. The audio processing notification unit 117 generates the RTCP packet that stores the Δd_{x_audio}. The audio processing notification unit 117 transmits the RTCP packet that stores the Δd_{x_audio} to a base indicated by the acquired transmission source base Rₓ.

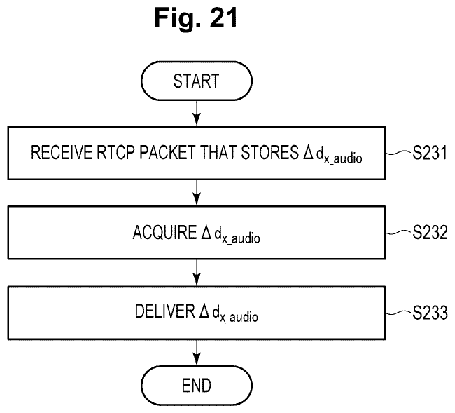

FIG. 21 is a flowchart illustrating a reception processing procedure and processing content of an RTCP packet that stores Δd_{x_audio} of the server 2 in the base R₁ according to the first embodiment. FIG. 21 illustrates the typical example of the processing of step S23 of the server 2.

The audio processing reception unit 2108 receives an RTCP packet that stores Δd_{x_audio} from the server 1 (step S231).

The audio processing reception unit 2108 acquires the Δd_{x_audio} stored in the RTCP packet that stores the Δd_{x_audio} (step S232).

The audio processing reception unit 2108 delivers the acquired Δd_{x_audio} to the return audio processing unit 2109 (step S233).

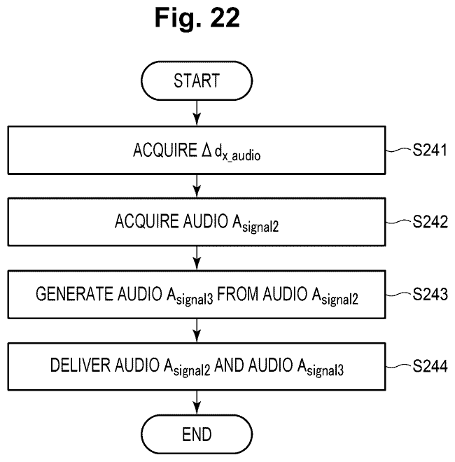

FIG. 22 is a flowchart illustrating a process processing procedure and processing content of an audio A_{signal2} of the server 2 in the base R₁ according to the first embodiment. FIG. 22 illustrates the typical example of the processing of step S24 of the server 2.

The return audio processing unit 2109 acquires Δd_{x_audio} from the audio processing reception unit 2108 (step S241).

The return audio processing unit 2109 acquires an audio A_{signal2} output from the return audio recording device 205 at the constant intervals I_{audio} (step S242). The audio A_{signal2} is an audio acquired in the base R₁ at a time at which the audio presentation device 204 reproduces an audio A_{signal1} in the base R₁.

The return audio processing unit 2109 generates an audio A_{signal3} from the acquired audio A_{signal2} according to a processing mode based on the acquired Δd_{x_audio} (step S243). In step S243, for example, the return audio processing unit 2109 determines the processing mode of the audio A_{signal2} on the basis of the Δd_{x_audio}. The return audio processing unit 2109 changes the processing mode of the audio A_{signal2} on the basis of the Δd_{x_audio}. The return audio processing unit 2109 changes the processing mode so as to lower the quality of the audio as the Δd_{x_audio} increases. The processing mode may include both performing processing on the audio A_{signal2} and not performing processing on the audio A_{signal2}. The processing mode includes a degree of processing on the audio A_{signal2}. In a case where the return audio processing unit 2109 performs processing on the audio A_{signal2}, the audio A_{signal3} is different from the audio A_{signal2}. In a case where the return audio processing unit 2109 does not perform processing on the audio A_{signal2}, the audio A_{signal3} is the same as the audio A_{signal2}.

The return audio processing unit 2109 performs processing of reducing the audibility on the basis of the Δd_{x_audio} when reproduction is performed by the return audio presentation device 104 of the base O. The processing of reducing the audibility includes processing of reducing the data size of the audio. When the Δd_{x_audio} is so small that viewers do not feel discomfort by reproduction of the audio A_{signal2} by the return audio presentation device 104, the return audio processing unit 2109 does not perform processing on the audio A_{signal2}. Furthermore, even in a case where the Δd_{x_audio} is too large, the return audio processing unit 2109 performs processing on the audio A_{signal2} so that the audio does not become completely auditorily unrecognizable. For example, a case of processing of changing the strength of the audio A_{signal2} will be described. Assuming that the strength of the audio A_{signal2} is s, the strength s′ of the audio A_{signal3} generated according to the processing mode is as follows.
(1) When 0 ms≤Δd_{x_audio}≤100 ms, s′=s
(2) When 100 ms<Δd_{x_audio}≤300 ms, s′={−(1/400)*Δd_{x_audio}+5/4}*s
(3) When 300 ms<Δd_{x_audio}, s′=0.5*s

The processing is not limited to the above as the change of the quality of the audio, and may be, in addition to the change of the strength of the sound, gradual reduction of a component of a high frequency by low-pass filtering in which a threshold is smaller as the Δd_{x_audio} is larger. In the processing, other processing may be used as long as the audibility of the processed audio A_{signal3} is lower than that of the audio A_{signal2} such that the larger the Δd_{x_audio}, the farther the sound is felt to be heard.

The return audio processing unit 2109 delivers the acquired audio A_{signal2} and the generated audio A_{signal3} to the return audio transmission unit 2110 (step S244).

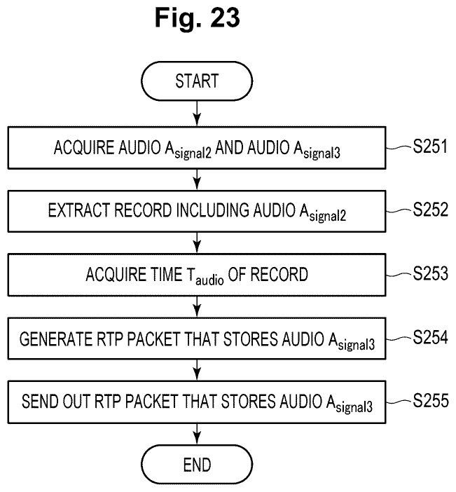

FIG. 23 is a flowchart illustrating a transmission processing procedure and processing content of an RTP packet that stores an audio A_{signal3} of the server 2 in the base R₁ according to the first embodiment. FIG. 23 illustrates the typical example of the processing of step S25 of the server 2.

The return audio transmission unit 2110 acquires an audio A_{signal2} and an audio A_{signal3} from the return audio processing unit 2109 (step S251). In step S251, for example, the return audio transmission unit 2110 simultaneously acquires an audio A_{signal2}, and an audio A_{signal3} at the constant intervals I_{audio}.

The return audio transmission unit 2110 refers to the audio time management DB 232 and extracts a record having audio data including the acquired audio A_{signal2} (step S252). The audio A_{signal2} acquired by the return audio transmission unit 2110 includes an audio A_{signal1} reproduced by the audio presentation device 204 and an audio generated at the base R₁ (cheers of the audience at the base R₁ and the like). In step S252, for example, the return audio transmission unit 2110 separates the two audios by a known audio analysis technology. The return audio transmission unit 2110 identifies the audio A_{signal1} reproduced by the audio presentation device 204 by separating the audios. The return audio transmission unit 2110 refers to the audio time management DB 232 and searches for audio data that matches the identified audio A_{signal1} reproduced by the audio presentation device 204. The return audio transmission unit 2110 refers to the audio time management DB 232 and extracts a record having the audio data that matches the identified audio A_{signal1} reproduced by the audio presentation device 204.

The return audio transmission unit 2110 refers to the audio time management DB 232 and acquires a time T_{audio} in the audio synchronization reference time column of the extracted record (step S253).

The return audio transmission unit 2110 generates an RTP packet that stores the audio A_{signal3} (step S254). In step S254, for example, the return audio transmission unit 2110 stores the acquired audio A_{signal3} in an RTP packet. The return audio transmission unit 2110 stores the acquired time T_{audio} in the header extension area of the RTP packet.

The return audio transmission unit 2110 sends out the generated RTP packet that stores the audio A_{signal3} to the IP network (step S255).

### (Effects)

As described above, in the first embodiment, the server 2 generates a video V_{signal3} from a video V_{signal2} according to a processing mode based on Δd_{x_video} indicated by notification from the server 1. The server 2 transmits the video V_{signal3} to the server 1. In a typical example, the server 2 changes the processing mode based on the Δd_{x_video}. The server 2 may change the processing mode so as to lower the quality of the video as the Δd_{x_video} increases. In this manner, the server 2 can process a video such that the video is inconspicuous when reproduced. In general, in a case where a video projected on a screen or the like is viewed from a certain point X, the video can be clearly visually recognized as long as the distance from the point X to the screen is within a certain range. On the other hand, as the distance increases, the video is small and blurred and is difficult to be visually recognized.

The server 2 generates an audio A_{signal3} from an audio A_{signal2} according to a processing mode based on Δd_{x_audio} indicated by notification from the server 1. The server 2 transmits the audio A_{signal3} to the server 1. In a typical example, the server 2 changes the processing mode based on the Δd_{x_audio}. The server 2 may change the processing mode so as to lower the quality of the audio as the Δd_{x_audio} increases. In this manner, the server 2 can process an audio such that the audio is hard to be heard when reproduced. In general, in a case where an audio reproduced by a speaker or the like is listened to from the certain point X, the audio can be clearly auditorily recognized at the same time as generation of a sound source as long as the distance from the point X to the speaker (sound source) is within a certain range. On the other hand, as the distance increases, the sound is delayed from the reproduction time of the sound and attenuated, and transmitting and listening to the sound are difficult.

The server 2 can reduce discomfort due to the magnitude of a data transmission delay time while conveying the state of viewers at a physically separated base by performing processing of reproducing viewing as described above on the basis of the Δd_{x_video} or the Δd_{x_audio}.

In this manner, the server 2 can reduce discomfort felt by viewers when a plurality of videos/audios transmitted from a plurality of bases at different times is reproduced in the base O.

Furthermore, the server 2 can reduce the data size of a video/audio by performing processing of the video/audio transmitted to the base O. As a result, a video/audio data transmission time is shortened. A network bandwidth required for data transmission is reduced.

### Second Embodiment

A second embodiment is an embodiment in which a video/audio transmitted from a base O and videos/audios transmitted from a plurality of bases of remote locations other than a base R are reproduced in the base R of a certain remote location.

Time information used for processing a video/audio is stored in a header extension area of an RTP packet transmitted and received between the base O and each of the bases R₁ to Rₙ. For example, the time information is in an absolute time format (hh:mm:ss.fff format).

Hereinafter, two bases R₁ and Rₙ will be mainly described as remote locations, and processing of reproducing a video/audio transmitted from the base O and a video/audio transmitted from the base R₁ in the base R₂ will be described. Description of reception processing of videos/audios returned and transmitted from the base R₁ and the base R₂ in the base O, reception processing and processing of a video/audio transmitted from the base R₂ in the base R₁, and transmission processing of a video/audio obtained by capturing and recording in the base R₂ in the base R₂ to the base O and the base R₁ will be omitted.

Although a video and an audio are described as being transmitted and received in RTP packetization, the present invention is not limited thereto. The video and audio may be processed and managed by the same functional unit/database (DB). Both the video and audio may be stored in one RTP packet and transmitted and received.

### Configuration Example

In the second embodiment, the same components as those of the first embodiment are denoted by the same reference signs, and description thereof will be omitted. In the second embodiment, differences from the first embodiment will be mainly described.

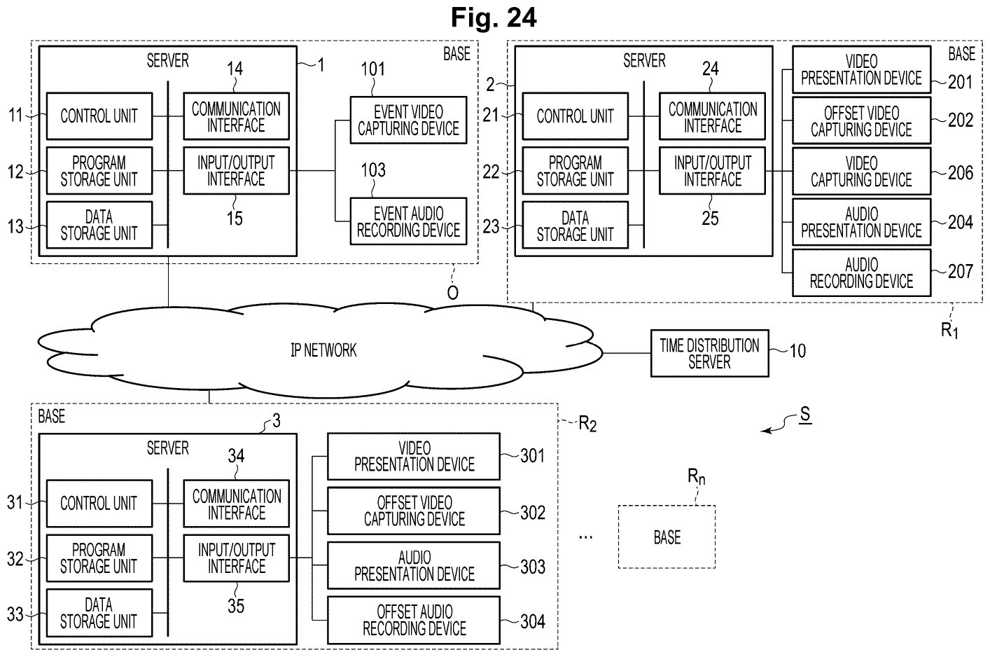

FIG. 24 is a block diagram illustrating an example of a hardware configuration of each electronic device included in a medium processing system S according to the second embodiment.

The medium processing system S includes a plurality of electronic devices included in the base O, a plurality of electronic devices included in each of the bases R₁ to Rₙ, and a time distribution server 10. The electronic devices in each of the bases and the time distribution server 10 can communicate with each other via an IP network.

The base O includes a server 1, an event video capturing device 101, and an event audio recording device 103 as in the first embodiment. The base O is an example of a first base.

As in the first embodiment, the base R₁ includes a server 2, a video presentation device 201, an offset video capturing device 202, and an audio presentation device 204. Unlike the first embodiment, the base R₁ includes a video capturing device 206 and an audio recording device 207. The base R₁ is an example of a second base. The server 2 is an example of a medium processing device.

The video capturing device 206 is a device including a camera that captures a video of the base R₁. For example, the video capturing device 206 captures a video of a state of the base R₁ where the video presentation device 201 that reproduces and displays a video transmitted from the base O to the base R₁ is installed. The video capturing device 206 is an example of the video capturing device.

The audio recording device 207 is a device including a microphone that records an audio of the base R₁. For example, the audio recording device 207 records an audio of a state of the base R₁ where the audio presentation device 204 that reproduces and outputs an audio transmitted from the base O to the base R₁ is installed. The audio recording device 207 is an example of the audio recording device.

The base R₂ includes a server 3, a video presentation device 301, an offset video capturing device 302, an audio presentation device 303, and an offset audio recording device 304. The base R₂ is an example of a third base different from the first base and the second base.

The server 3 is an electronic device that controls each of the electronic devices included in the base R₂.

The video presentation device 301 is a device including a display that reproduces and displays a video transmitted from the base O to the base R₂ and a video transmitted from the base R₁ and each of bases R₃ to Rₙ to the base R₂. The video presentation device 301 is an example of the presentation device.

The offset video capturing device 302 is a device capable of recording a capturing time. The offset video capturing device 302 is a device including a camera installed so as to be able to capture the entire video display area of the video presentation device 301. The offset video capturing device 302 is an example of the video capturing device.

The audio presentation device 303 is a device including a speaker that reproduces and outputs an audio transmitted from the base O to the base R₂ and an audio transmitted from the base R₁ and each of the bases R₃ to Rₙ to the base R₂. The audio presentation device 303 is an example of the presentation device.

The offset audio recording device 304 is a device capable of recording a recording time. The offset audio recording device 304 is a device including a microphone installed so as to be able to record an audio reproduced by the audio presentation device 303. The offset audio recording device 304 is an example of an audio recording device.

A configuration example of the server 3 will be described.

The server 3 includes a control unit 31, a program storage unit 32, a data storage unit 33, a communication interface 34, and an input/output interface 35. The elements included in the server 3 are connected to each other via a bus.

The control unit 31 can be formed similarly to the control unit 11. A processor deploys a ROM or a program stored in the program storage unit 32 in a RAM. The processor executes a program deployed in the RAM, thereby the control unit 31 implements each functional unit described below. The control unit 31 is included in a computer.

The program storage unit 32 can be formed similarly to the program storage unit 12.

The data storage unit 33 can be formed similarly to the data storage unit 13.

The communication interface 34 can be formed similarly to the communication interface 14. The communication interface 34 includes various interfaces that communicatively connect the server 3 to other electronic devices.

The input/output interface 35 can be formed similarly to the input/output interface 15. The input/output interface 35 enables communication between the server 3 and each of the video presentation device 301, the offset video capturing device 302, the audio presentation device 303, and the offset audio recording device 304.

Note that a hardware configuration of the server 3 is not limited to the above-described configuration. The server 3 can appropriately omit and change the above-described components and add a new component.

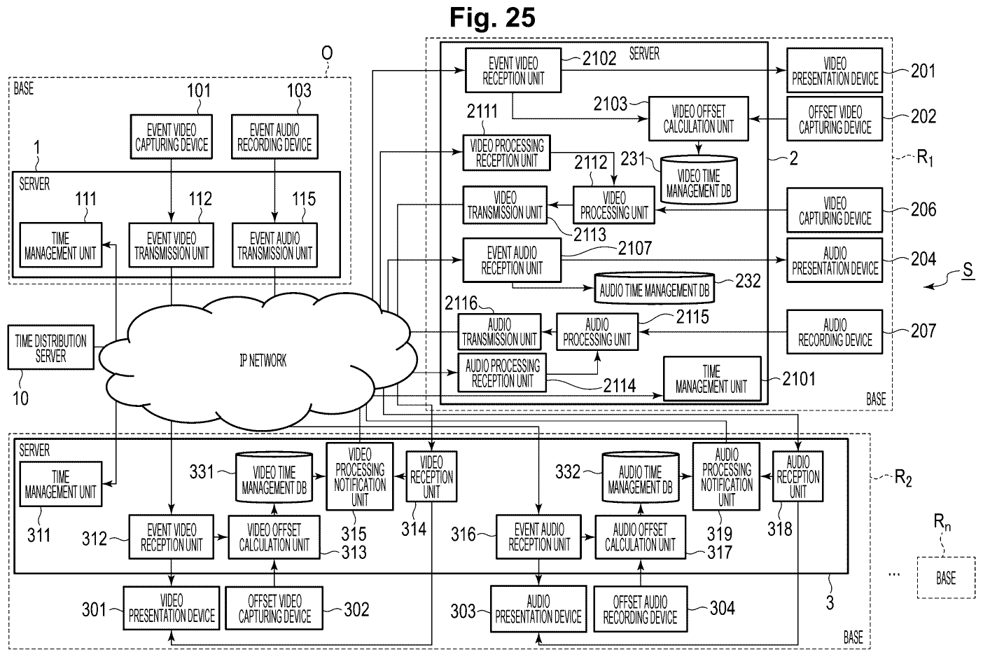

FIG. 25 is a block diagram illustrating an example of a software configuration of each of the electronic devices included in the medium processing system S according to the second embodiment.

As in the first embodiment, the server 1 includes a time management unit 111, an event video transmission unit 112, and an event audio transmission unit 115. Each functional unit is implemented by execution of a program by the control unit 11. It can also be said that each functional unit is included in the control unit 11 or the processor. Each functional unit can be read as the control unit 11 or the processor.

As in the first embodiment, the server 2 includes a time management unit 2101, an event video reception unit 2102, a video offset calculation unit 2103, an event audio reception unit 2107, a video time management DB 231, and an audio time management DB 232. Unlike the first embodiment, the server 2 includes a video processing reception unit 2111, a video processing unit 2112, a video transmission unit 2113, an audio processing reception unit 2114, an audio processing unit 2115, and an audio transmission unit 2116. Each functional unit is implemented by execution of a program by the control unit 21. It can also be said that each functional unit is included in the control unit 21 or a processor. Each functional unit can be read as the control unit 21 or the processor. The video time management DB 231 and the audio time management DB 232 are implemented by the data storage unit 23.

The video processing reception unit 2111 receives an RTCP packet that stores Δd_{x_video} from each of servers of bases R₂ to Rₙ. The Δd_{x_video} is a value regarding a data transmission delay between the base R₁ and each of the bases R₂ to Rₙ. The Δd_{x_video} is an example of a transmission delay time. The Δd_{x_video} is different in each of the bases R₂ to Rₙ. The RTCP packet that stores the Δd_{x_video} is an example of notification regarding the transmission delay time. The RTCP packet is an example of a packet. The video processing reception unit 2111 is an example of a first reception unit.

The video processing unit 2112 generates a video V_{signal3} from a video V_{signal2} according to a processing mode based on the Δd_{x_video}. The video V_{signal2} is a video acquired in the base R₁ at a time at which a video V_{signal1} is reproduced in the base R₁. Acquiring the video V_{signal2} includes capturing the video V_{signal2} by the video capturing device 206. Acquiring the video V_{signal2} includes sampling the video V_{signal2} obtained by capturing by the video capturing device 206. The video V_{signal2} is an example of a second video. The video V_{signal3} is an example of a third video. The video processing unit 2112 is an example of a processing unit.

The video transmission unit 2113 transmits an RTP packet that stores the video V_{signal3} to any one of the servers of the bases R₂ to Rₙ via the IP network. A time T_{video} is provided to the RTP packet that stores the video V_{signal3}. The RTP packet that stores the video V_{signal3} includes the time T_{video} associated with a presentation time t₁ that matches a time t that is an absolute time at which the video V_{signal3} is obtained by capturing. Since the video V_{signal3} is generated from the video V_{signal2}, the RTP packet that stores the video V_{signal3} is an example of a packet regarding the video V_{signal2}. An RTP packet is an example of a packet. The video transmission unit 2113 is an example of a transmission unit.

The audio processing reception unit 2114 receives an RTCP packet that stores Δd_{x_audio} from each of the servers of the bases R₂ to Rₙ. The Δd_{x_audio} is a value regarding a data transmission delay between the base R₁ and each of the bases R₂ to Rₙ. The Δd_{x_audio} is an example of a transmission delay time. The Δd_{x_audio} is different in each of the bases R₂ to Rₙ. The RTCP packet that stores the Δd_{x_audio} is an example of notification regarding the transmission delay time. The audio processing reception unit 2114 is an example of the first reception unit.

The audio processing unit 2115 generates an audio A_{signal3} from an audio A_{signal2} according to a processing mode based on the Δd_{x_audio}. The audio A_{signal2} is an audio acquired in the base R₁ at a time at which an audio A_{signal1} is reproduced in the base R₁. Acquiring the audio A_{signal2} includes recording the audio A_{signal2} by the audio recording device 207. Acquiring the audio A_{signal2} includes sampling the audio A_{signal2} obtained by recording by the audio recording device 207. The audio A_{signal2} is an example of a second audio. The audio A_{signal3} is an example of a third audio. The audio processing unit 2115 is an example of a processing unit.

The audio transmission unit 2116 transmits an RTP packet that stores the audio A_{signal3} to any one of the servers of the bases R₂ to Rₙ via the IP network. A time T_{audio} is provided to the RTP packet that stores the audio A_{signal3}. Since the audio A_{signal3} is generated from the audio A_{signal2}, the RTP packet that stores the audio A_{signal3} is an example of a packet regarding the audio A_{signal2}. The audio transmission unit 2116 is an example of a transmission unit.

The server 3 includes a time management unit 311, an event video reception unit 312, a video offset calculation unit 313, a video reception unit 314, a video processing notification unit 315, an event audio reception unit 316, an audio offset calculation unit 317, an audio reception unit 318, an audio processing notification unit 319, a video time management DB 331, and an audio time management DB 332. Each functional unit is implemented by execution of a program by the control unit 31. It can also be said that each functional unit is included in the control unit 31 or a processor. Each functional unit can be read as the control unit 31 or the processor. The video time management DB 331 and the audio time management DB 332 are implemented by the data storage unit 33.

The time management unit 311 performs time synchronization with the time distribution server 10 using a known protocol such as NTP or PTP, and manages the reference system clock. The time management unit 311 manages the same reference system clock as the reference system clock managed by the server 1 and the server 2. The reference system clock managed by the time management unit 311 and the reference system clock managed by the server 1 and the server 2 are time-synchronized.

The event video reception unit 312 receives an RTP packet that stores a video V_{signal1} an from the server 1 via the IP network. The video V_{signal1} is a video acquired at a time T_{video} that is an absolute time in the base O. Acquiring the video V_{signal1} includes capturing the video V_{signal1} by the event video capturing device 101. Acquiring the video V_{signal1} includes sampling the video V_{signal1} obtained by capturing by the event video capturing device 101. A time T_{video} is provided to the RTP packet that stores the video V_{signal1}. The time T_{video} is a time at which the video V_{signal1} is acquired in the base O. The video V_{signal1} is an example of a first video. The time T_{video} is an example of a first time.

The video offset calculation unit 313 calculates a presentation time t₁ that is an absolute time at which the video V_{signal1} is reproduced by the video presentation device 301 in the base R₂. The presentation time t₁ is an example of a third time.

The video reception unit 314 receives an RTP packet that stores a video V_{signal3} from each of servers of the base R₁ and the bases R₃ to Rₙ via the IP network.

The video processing notification unit 315 generates Δd_{x_video} for each of the base R₁ and the bases R₃ to Rₙ, and transmits an RTCP packet that stores the Δd_{x_video} to each of the servers of the base R₁ and the bases R₃ to Rₙ.

The event audio reception unit 316 receives an RTP packet that stores an audio A_{signal1} from the server 1 via the IP network. The audio A_{signal1} is an audio acquired at a time T_{audio} that is an absolute time in the base O. Acquiring the audio A_{signal1} includes recording the audio A_{signal1} by the event audio recording device 103. Acquiring the audio A_{signal1} includes sampling the audio A_{signal1} obtained by recording by the event audio recording device 103. The time T_{audio} is provided to the RTP packet that stores the audio A_{signal1}. The time T_{audio} is a time at which the audio A_{signal1} is acquired in the base O. The audio A_{signal1} is an example of a first audio. The time T_{audio} is an example of the first time.

The audio offset calculation unit 317 calculates a presentation time t_{L} that is an absolute time at which the audio A_{signal1} is reproduced by the audio presentation device 303 in the base R₂. The presentation time t₂ is an example of the third time.

The audio reception unit 318 receives an RTP packet that stores an audio A_{signal3} from each of the servers of the base R₁ and the bases R₃ to Rₙ via the IP network.

The audio processing notification unit 319 generates Δd_{x_audio} for each of the base R₁ and the bases R₃ to Rₙ, and transmits an RTCP packet that stores the Δd_{x_audio} to each of the servers of the base R₁ and the bases R₃ to Rₙ.

The video time management DB 331 may have a data structure similar to that of the video time management DB 231. The video time management DB 331 is a DB that stores times T_{video} acquired from the video offset calculation unit 313 and presentation times t₁ in association with each other.

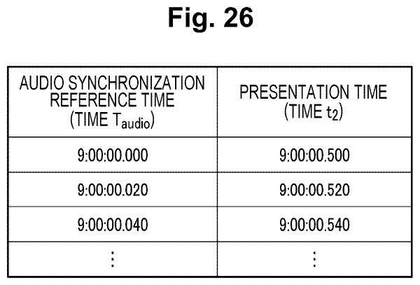

FIG. 26 is a diagram illustrating an example of a data structure of the audio time management DB 332 included in the server 3 of the base R₂ according to the second embodiment.

The audio time management DB 332 is a DB that stores times T_{audio} acquired from the audio offset calculation unit 317 and presentation times t₂ in association with each other.

The audio time management DB 332 includes an audio synchronization reference time column and a presentation time column. The audio synchronization reference time column stores the times T_{audio}. The presentation time column stores the presentation times to.

### Operation Example

Hereinafter, operation of the base O, the base R₁, the base R₂ will be described as an example.

### (1) Process and Reproduce Video

Video processing of the server 1 in the base O will be described.

The event video transmission unit 112 transmits an RTP packet that stores a video V_{signal1} to each of servers of the bases R₁ to Rₙ via the IP network. A time T_{video} is provided to the RTP packet that stores the video V_{signal1}. The time T_{video} is time information used to process a video in each of bases (R₁, R₂, . . . , Rₙ) other than the base O. The processing of the event video transmission unit 112 may be similar to the processing described in the first embodiment using FIG. 7, and description thereof will be omitted.

Video processing of the server 2 in the base R₁ will be described.

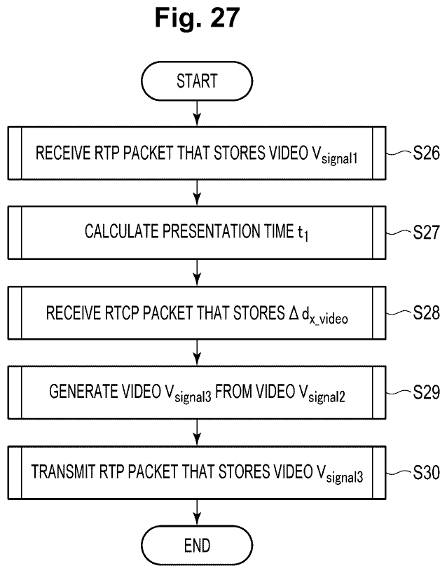

FIG. 27 is a flowchart illustrating a video processing procedure and processing content of the server 2 in the base R₁ according to the second embodiment.

The event video reception unit 2102 receives an RTP packet that stores a video V_{signal1} from the server 1 via the IP network (step S26).

A typical example of the processing of the event video reception unit 2102 in step S26 may be similar to the processing described in the first embodiment using FIG. 8, and description thereof will be omitted.

The video offset calculation unit 2103 calculates a presentation time t₁ at which the video V_{signal1} is reproduced by the video presentation device 201 (step S27).

A typical example of the processing of the video offset calculation unit 2103 in step S27 may be similar to the processing described in the first embodiment using FIG. 9, and description thereof will be omitted.

The video processing reception unit 2111 receives an RTCP packet that stores Δd_{x_video} from the server 3 (step S28).

A typical example of the processing of the video processing reception unit 2111 in step S28 may be similar to the processing of the video processing reception unit 2104 described in the first embodiment using FIG. 12. Description of the processing of the video processing reception unit 2111 will be omitted by the notation of the “video processing reception unit 2104”, the “return video processing unit 2105”, and the “server 1” being replaced with the “video processing reception unit 2111”, the “video processing unit 2112”, and the “server 3” in the description using FIG. 12.

The video processing unit 2112 generates a video V_{signal3} from a video V_{signal2} according to a processing mode based on the Δd_{x_video} (step S29).

A typical example of the processing of the video processing unit 2112 in step S29 may be similar to the processing of the return video processing unit 2105 described in the first embodiment using FIG. 13. Description of the processing of the video processing unit 2112 will be omitted by the notation of the “video processing reception unit 2104”, the “return video processing unit 2105”, the “return video capturing device 203”, the “base O”, and the “return video presentation device 102” being replaced with the “video processing reception unit 2111”, the “video processing unit 2112”, the “video capturing device 206”, the “base R₂”, and the “video presentation device 301” in the description using FIG. 13.

The video transmission unit 2113 transmits an RTP packet that stores the video V_{signal3} to the server 3 via the IP network (step S30).

A typical example of the processing of the video transmission unit 2113 in step S30 may be similar to the processing of the return video transmission unit 2106 described in the first embodiment using FIG. 14. Description of the processing of the video transmission unit 2113 will be omitted by the notation of the “return video processing unit 2105” and the “return video transmission unit 2106” being replaced with the “video processing unit 2112” and the “video transmission unit 2113” in the description using FIG. 14.

Video processing of the server 3 in the base R₂ will be described.

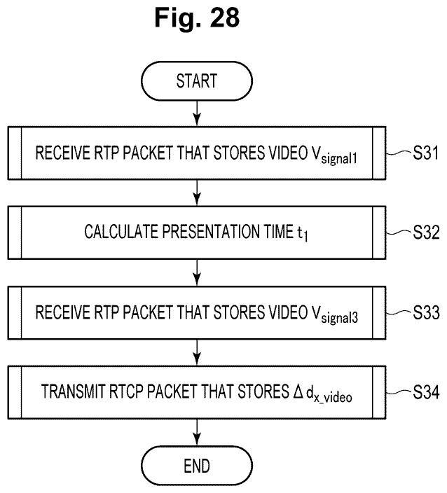

FIG. 28 is a flowchart illustrating a video processing procedure and processing content of the server 3 in the base R₂ according to the second embodiment.

The event video reception unit 312 receives an RTP packet that stores a video V_{signal1} from the server 1 via the IP network (step S31).

A typical example of the processing of the event video reception unit 312 in step S31 may be similar to the processing of the event video reception unit 2102 described in the first embodiment using FIG. 8.

Description of the processing of the event video reception unit 312 will be omitted by the notation of the “event video reception unit 2102”, the “video offset calculation unit 2103”, and the “video presentation device 201” being replaced with the “event video reception unit 312”, the “video offset calculation unit 313”, and the “video presentation device 301” in the description using FIG. 8.

The video offset calculation unit 313 calculates a presentation time t₁ at which the video V_{signal1} is reproduced by the video presentation device 301 (step S32).

A typical example of the processing of the video offset calculation unit 313 in step S32 may be similar to the processing of the video offset calculation unit 2103 described in the first embodiment using FIG. 9. Description of the processing of the video offset calculation unit 313 will be omitted being the notation of the “event video reception unit 2102”, the “video offset calculation unit 2103”, the “offset video capturing device 202”, and the “video time management DB 231” being replaced with the “event video reception unit 312”, the “video offset calculation unit 313”, the “offset video capturing device 302”, and the “video time management DB 331” in the description using FIG. 9.

The video reception unit 314 receives an RTP packet that stores a video V_{signal3} from the server 2 of the base R₁ via the IP network (step S33).

A typical example of the processing of the video reception unit 314 in step S33 may be similar to the processing of the return video reception unit 113 described in the first embodiment using FIG. 10.

Description of the processing of the video reception unit 314 will be omitted by the notation of the “time management unit 111”, the “return video reception unit 113”, the “video processing notification unit 114”, the “return video presentation device 102”, and the “return video transmission unit 2106” being replaced with the “time management unit 311”, the “video reception unit 314”, the “video processing notification unit 315”, the “video presentation device 301”, and the “video transmission unit 2113” in the description using FIG. 10.

The video processing notification unit 315 generates Δd_{x_video} for the base R₁, and transmits an RTCP packet that stores the Δd_{x_video} to the server 1 of the base R₁ (step S34).

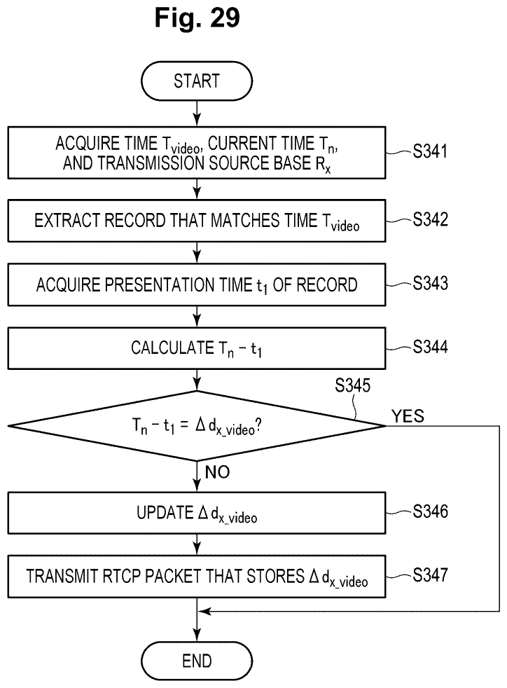

FIG. 29 is a flowchart illustrating a transmission processing procedure and processing content of an RTCP packet that stores Δd_{x_video} of the server 3 in the base R₂ according to the second embodiment. FIG. 29 illustrates the typical example of the processing of step S34 of the server 3.

The video processing notification unit 315 acquires a time T_{video}, a current time Tₙ, and a transmission source base Rₓ from the video reception unit 314 (step S341).

The video processing notification unit 315 refers to the video time management DB 331 and extracts a record having a video synchronization reference time that matches the acquired time T_{video} (step S342).

The video processing notification unit 315 refers to the video time management DB 331 and acquires a presentation time t₁ in the presentation time column of the extracted record (step S343). The presentation time t₁ is a time at which a video V_{signal1} acquired at the time T_{video} in the base O is reproduced by the video presentation device 301 in the base R₂.

The video processing notification unit 315 calculates a time (Tₙ−t₁) obtained by subtracting the presentation time t₁ from the current time Tₙ on the basis of the current time Tₙ and the presentation time t₁ (step S344).

The video processing notification unit 315 determines whether the time (Tₙ−t₁) matches current Δd_{x_video} (step S345). The Δd_{x_video} is a value of a difference between the current time Tₙ and the presentation time t₁. The current Δd_{x_video} is a time (Tₙ−t₁) calculated before the time (Tₙ−t₁) calculated this time. An initial value of the Δd_{x_video} is set to 0. In a case where the time (Tₙ−t₁) matches the current Δd_{x_video} (YES in step S345), the processing ends. In a case where the time (Tₙ−t₁) does not match the current Δd_{x_video} (NO in step S345), the processing proceeds from step S345 to step S346. The time (Tₙ−t₁) not matching the current Δd_{x_video} corresponds to the Δd_{x_video} having changed.

The video processing notification unit 315 updates the Δd_{x_video} to Δd_{x_video}=Tₙ−t₁ (step S346).

The video processing notification unit 315 transmits an RTCP packet that stores the Δd_{x_video} (step S347). In step S347, for example, the video processing notification unit 315 describes the updated Δd_{x_video} using an APP in the RTCP. The video processing notification unit 315 generates the RTCP packet that stores the Δd_{x_video}. The video processing notification unit 315 transmits the RTCP packet that stores the Δd_{x_video} to the base R₁ indicated by the acquired transmission source base Rₓ.

### (2) Process and Reproduce Audio

Audio processing of the server 1 in the base O will be described.

The event audio transmission unit 115 transmits an RTP packet that stores an audio A_{signal1} to each of the servers of the bases R₁ to Rₙ via the IP network. A time T_{audio} is provided to the RTP packet that stores the audio A_{signal1}. The time T_{audio} is time information used to process an audio in each of the bases (R₁, R₂, . . . , Rₙ) other than the base O. The processing of the event audio transmission unit 115 may be similar to the processing described in the first embodiment using FIG. 17, and description thereof will be omitted.

Audio processing of the server 2 in the base R₁ will be described.

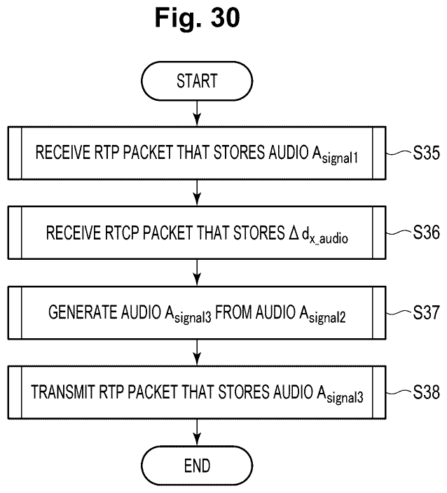

FIG. 30 is a flowchart illustrating an audio processing procedure and processing content of the server 2 in the base R₁ according to the second embodiment.

The event audio reception unit 2107 receives an RTP packet that stores an audio A_{signal1} from the server 1 via the IP network (step S35).

A typical example of the processing of the event audio reception unit 2107 in step S35 may be similar to the processing described in the first embodiment using FIG. 18, and description thereof will be omitted.

The audio processing reception unit 2114 receives an RTCP packet that stores Δd_{x_audio} from the server 3 (step S36).

A typical example of the processing of the audio processing reception unit 2114 in step S36 may be similar to the processing of the audio processing reception unit 2108 described in the first embodiment using FIG. 21. Description of the processing of the audio processing reception unit 2114 will be omitted by the notation of the “audio processing reception unit 2108”, the “return audio processing unit 2109”, and the “server 1” being replaced with the “audio processing reception unit 2114”, the “audio processing unit 2115”, and the “server 3” in the description using FIG. 21.

The audio processing unit 2115 generates an audio A_{signal3} from an audio A_{signal2} according to a processing mode based on the Δd_{x_audio} (step S37).

A typical example of the processing of the audio processing unit 2115 in step S37 may be similar to the processing of the return audio processing unit 2109 described in the first embodiment using FIG. 22. Description of the processing of the audio processing unit 2115 will be omitted by the notation of the “audio processing reception unit 2108”, the “return audio processing unit 2109”, the “return audio recording device 205”, the “base O”, and the “return audio presentation device 104” being replaced with the “audio processing reception unit 2114”, the “audio processing unit 2115”, the “audio presentation device 204”, the “base R₂”, and the “audio presentation device 303” in the description using FIG. 22.

The audio transmission unit 2116 transmits an RTP packet that stores the audio A_{signal3} to the server 3 via the IP network (step S38).

A typical example of the processing of the audio transmission unit 2116 in step S38 may be similar to the processing of the return audio transmission unit 2110 described in the first embodiment using FIG. 23.

Description of the processing of the audio transmission unit 2116 will be omitted by the notation of the “return audio processing unit 2109” and the “return audio transmission unit 2110” being replaced with the “audio processing unit 2115” and the “audio transmission unit 2116” in the description using FIG. 23.

Audio processing of the server 3 in the base R₂ will be described.

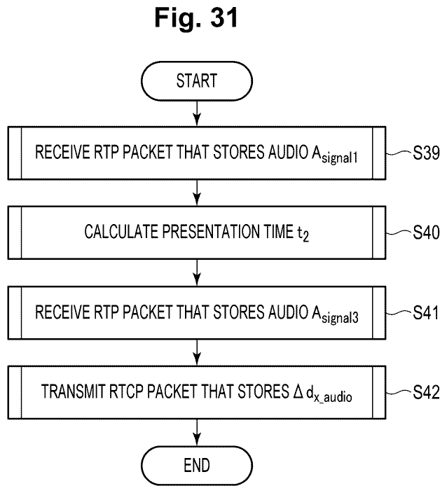

FIG. 31 is a flowchart illustrating an audio processing procedure and processing content of the server 3 in the base R₂ according to the second embodiment.

The event audio reception unit 316 receives an RTP packet that stores an audio A_{signal1} from the server 1 via the IP network (step S39). A typical example of processing of step S39 will be described below.

The audio offset calculation unit 317 calculates a presentation time t₂ at which the audio A_{signal1} is reproduced by the audio presentation device 303 (step S40). A typical example of processing of step S40 will be described below.

The audio reception unit 318 receives an RTP packet that stores an audio A_{signal3} from the server 2 of the base R₁ via the IP network (step S41).

A typical example of the processing of the audio reception unit 318 in step S41 may be similar to the processing of the return audio reception unit 116 described in the first embodiment using FIG. 19.

Description of the processing of the audio reception unit 318 will be omitted by the notation of the “return audio reception unit 116”, the “audio processing notification unit 117”, the “return audio presentation device 104”, and the “return audio transmission unit 2110” being replaced with the “audio reception unit 318”, the “audio processing notification unit 319”, the “audio presentation device 303”, and the “audio transmission unit 2116” in the description using FIG. 19.

The audio processing notification unit 319 generates Δd_{x_audio} for the base R₁, and transmits an RTCP packet that stores the Δd_{x_audio} to the server 1 of the base R₁ (step S42). A typical example of processing of step S42 will be described below.

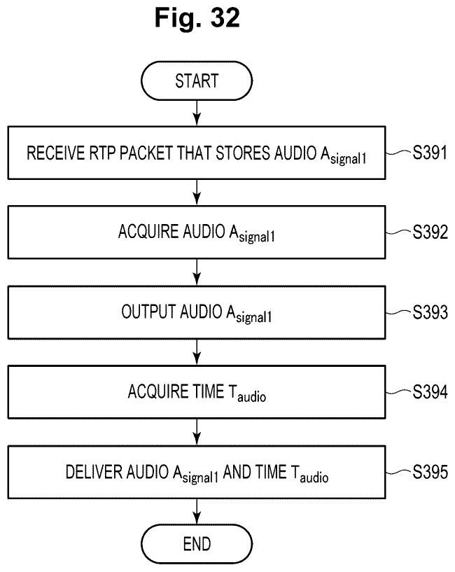

FIG. 32 is a flowchart illustrating a reception processing procedure and processing content of an RTP packet that stores an audio A_{signal1} of the server 3 in the base R₂ according to the second embodiment. FIG. 32 illustrates the typical example of the processing of step S39 of the server 3.

The event audio reception unit 316 receives an RTP packet that stores an audio A_{signal1} sent out from the event audio transmission unit 115 via the IP network (step S391).

The event audio reception unit 316 acquires the audio A_{signal1} stored in the received RTP packet that stores the audio A_{signal1} (step S392).

The event audio reception unit 316 outputs the acquired audio A_{signal1} to the audio presentation device 303 (step S393). The audio presentation device 303 reproduces and outputs the audio A_{signal1}.

The event audio reception unit 316 acquires a time T_{audio} stored in the header extension area of the received RTP packet that stores the audio A_{signal1} (step S394).

The event audio reception unit 316 delivers the acquired audio A_{signal1} and time T_{audio} to the audio offset calculation unit 317 (step S395).

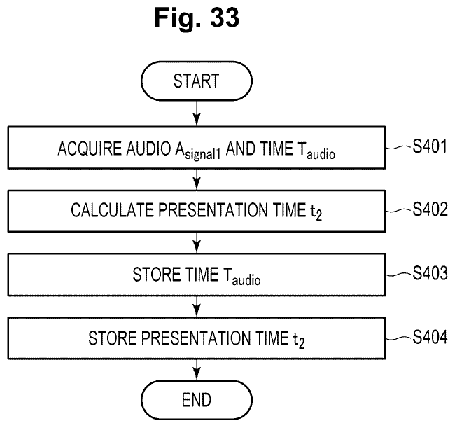

FIG. 33 is a flowchart illustrating a calculation processing procedure and processing content of a presentation time t₂ of the server 3 in the base R₂ according to the second embodiment. FIG. 33 illustrates the typical example of the processing of step S40 of the server 3.

The audio offset calculation unit 317 acquires an audio A_{signal1} and a time T_{audio} from the event audio reception unit 316 (step S401).

The audio offset calculation unit 317 calculates a presentation time t_{L} on the basis of the acquired audio A_{signal1} and an audio input from the offset audio recording device 304 (step S402). The audio acquired by the offset audio recording device 304 includes the audio A_{signal1} reproduced by the audio presentation device 303 and an audio generated at the base R₂ (cheers of the audience at the base R₂ and the like). In step S402, for example, the audio offset calculation unit 317 separates the two audios by a known audio analysis technology. The audio offset calculation unit 317 acquires a presentation time t₂ that is an absolute time at which the audio A_{signal1} is reproduced by the audio presentation device 303 by separating the audios.

The audio offset calculation unit 317 stores the acquired time T_{audio} in the audio synchronization reference time column of the audio time management DB 332 (step S403).

The audio offset calculation unit 317 stores the acquired presentation time t₂ in the presentation time column of the audio time management DB 332 (step S404).

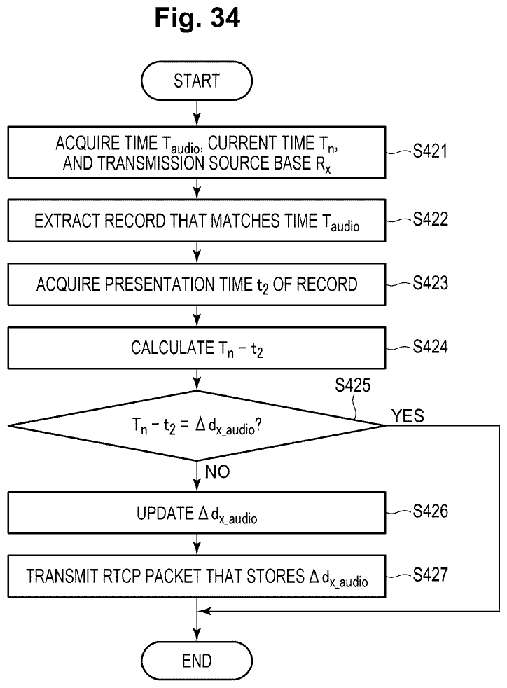

FIG. 34 is a flowchart illustrating a transmission processing procedure and processing content of an RTCP packet that stores Δd_{x_audio} of the server 3 in the base R₂ according to the second embodiment. FIG. 34 illustrates the typical example of the processing of step S42 of the server 3.

The audio processing notification unit 319 acquires a time T_{audio}, a current time Tₙ, and a transmission source base Rₓ from the audio reception unit 318 (step S421).

The audio processing notification unit 319 refers to the audio time management DB 332 and extracts a record having the audio synchronization reference time that matches the acquired time T_{audio} (step S422).

The audio processing notification unit 319 refers to the audio time management DB 332 and acquires a presentation time t₂ in the presentation time column of the extracted record (step S423). The presentation time t₂ is a time at which an audio A_{signal1} acquired at the time T_{audio} in the base O is reproduced by the audio presentation device 303 in the base R₂.

The audio processing notification unit 319 calculates a time (Tₙ−t₂) obtained by subtracting the presentation time t₂ from the current time Tₙ on the basis of the current time Tₙ and the presentation time t₂ (step S424).

The audio processing notification unit 319 determines whether the time (Tₙ−tₙ) matches current Δd_{x_audio} (step S425). The Δd_{x_audio} is a value of a difference between the current time Tₙ and the presentation time t₂. The current Δd_{x_audio} is a time (Tₙ−t₂) calculated before the time (Tₙ−t₂) calculated this time. An initial value of the Δd_{x_audio} is set to 0. In a case where the time (Tₙ−t₂) matches the current Δd_{x_audio} (YES in step S425), the processing ends. In a case where the time (Tₙ−t₂) does not match the current Δd_{x_audio} (NO in step S425), the processing proceeds from step S425 to step S426. The time (Tₙ−t₂) not matching the current Δd_{x_audio} corresponds to the Δd_{x_audio} having changed.

The audio processing notification unit 319 updates the Δd_{x_audio} to Δd_{x_audio}=Tₙ−T_{audio} (step S426).

The audio processing notification unit 319 transmits an RTCP packet that stores the Δd_{x_audio} (step S427). In step S427, for example, the audio processing notification unit 319 describes the updated Δd_{x_audio} using an APP in the RTCP. The audio processing notification unit 319 generates the RTCP packet that stores the Δd_{x_audio}. The audio processing notification unit 319 transmits the RTCP packet that stores the Δd_{x_audio} to a base indicated by the acquired transmission source base Rₓ.

### (Effects)

As described above, in the second embodiment, the server 2 generates a video V_{signal3} from a video V_{signal2} according to a processing mode based on Δd_{x_video} indicated by notification from the server 3. The server 2 transmits the video V_{signal3} to the server 3. In a typical example, the server 2 changes the processing mode based on the Δd_{x_video}. The server 2 may change the processing mode so as to lower the quality of the video as the Δd_{x_video} increases. In this manner, the server 2 can process a video such that the video is inconspicuous when reproduced. In general, in a case where a video projected on a screen or the like is viewed from a certain point X, the video can be clearly visually recognized as long as the distance from the point X to the screen is within a certain range. On the other hand, as the distance increases, the video is small and blurred and is difficult to be visually recognized.

The server 2 generates an audio A_{signal3} from an audio A_{signal2} according to a processing mode based on Δd_{x_audio} indicated by notification from the server 3. The server 2 transmits the video V_{signal3} to the server 3. In a typical example, the server 2 changes the processing mode based on the Δd_{x_video}. The server 2 may change the processing mode so as to lower the quality of the audio as the Δd_{x_video} increases. In this manner, the server 2 can process an audio such that the audio is hard to be heard when reproduced. In general, in a case where an audio reproduced by a speaker or the like is listened to from the certain point X, the audio can be clearly auditorily recognized at the same time as generation of a sound source as long as the distance from the point X to the speaker (sound source) is within a certain range. On the other hand, as the distance increases, the sound is delayed from the reproduction time of the sound and attenuated, and transmitting and listening to the sound are difficult.

The server 2 can reduce discomfort due to the magnitude of a data transmission delay time while conveying the state of viewers at a physically separated base by performing processing of reproducing viewing as described above on the basis of the Δd_{x_video} or the Δd_{x_video}.

In this manner, the server 2 can reduce discomfort felt by viewers when a plurality of videos/audios transmitted from a plurality of bases at different times is reproduced in the base R₂.

Furthermore, the server 2 can reduce the data size of a video/audio by performing processing of the video/audio transmitted to the base R₂. As a result, a video/audio data transmission time is shortened. A network bandwidth required for data transmission is reduced.

### OTHER EMBODIMENTS

The medium processing device may be implemented by one device as described in the above examples, or may be implemented by a plurality of devices in which functions are distributed.

The program may be transferred in a state of being stored in an electronic device, or may be transferred in a state of not being stored in an electronic device. In the latter case, the program may be transferred via a network or may be transferred in a state of being recorded in a recording medium. The recording medium is a non-transitory tangible medium. The recording medium is a computer-readable medium. The recording medium is only required to be a medium that can store a program and can be read by a computer, such as a CD-ROM or a memory card, and any form can be used.

Although the embodiments of the present invention have been described in detail above, the above description is merely an example of the present invention in all respects. It goes without saying that various improvements and modifications can be made without departing from the scope of the present invention. That is, in carrying out the present invention, a specific configuration according to the embodiment may be appropriately employed.

In short, the present invention is not limited to the above-described embodiments without any change, and can be embodied by modifying the constituents without departing from the concept of the invention at the implementation stage. Various inventions can be implemented by appropriately combining a plurality of the constituents disclosed in the above-described embodiments. For example, some constituents may be omitted from all the constituents described in the embodiments. The constituents in different embodiments may be appropriately combined.

### REFERENCE SIGNS LIST

1 Server
2. Server
3 Server
10 Time distribution server
11 Control unit
12 Program storage unit
13 Data storage unit
14 Communication interface
15 Input/output interface
21 Control unit
22 Program storage unit
23 Data storage unit
24 Communication interface
25 Input/output interface
31 Control unit
32 Program storage unit
33 Data storage unit
34 Communication interface
35 Input/output interface
101 Event video capturing device
102 Return video presentation device
103 Event audio recording device
104 Return audio presentation device
111 Time management unit
112 Event video transmission unit
113 Return video reception unit
114 Video processing notification unit
115 Event audio transmission unit
116 Return audio reception unit
117 Audio processing notification unit
201 Video presentation device
202 Offset video capturing device
203 Return video capturing device
204 Audio presentation device
205 Return audio recording device
206 Video capturing device
207 Audio recording device
2101 Time management unit
2102 Event video reception unit
2103 Video offset calculation unit
2104 Video processing reception unit
2105 Return video processing unit
2106 Return video transmission unit
2107 Event audio reception unit
2108 Audio processing reception unit
2109 Return audio processing unit
2110 Return audio transmission unit
2111 Video processing reception unit
2112 Video processing unit
2113 Video transmission unit
2114 Audio processing reception unit
2115 Audio processing unit
2116 Audio transmission unit
231 Video time management DB
232 Audio time management DB
301 Video presentation device
302 Offset video capturing device
303 Audio presentation device
304 Offset audio recording device
311 Time management unit
312 Event video reception unit
313 Video offset calculation unit
314 Video reception unit
315 Video processing notification unit
316 Event audio reception unit
317 Audio offset calculation unit
318 Audio reception unit
319 Audio processing notification unit
331 Video time management DB
332 Audio time management DB
O Base
R₁ to Rₙ Base
S Medium processing system

1. A medium processing device of a second base different from a first base, the medium processing device comprising:
a first receiver to receive, from an electronic device in the first base, notification regarding a transmission delay time based on a first time at which a medium is acquired in the first base and a second time associated with reception, by an electronic device in the first base, of a packet regarding a medium acquired in the second base at a time at which the medium is reproduced in the second base;
a second receiver to receive a packet that stores a first medium acquired in the first base from an electronic device in the first base and outputs the first medium to a presentation device;
processing circuitry configured to generate a third medium from a second medium acquired in the second base at a time at which the first medium is reproduced in the second base according to a processing mode based on the transmission delay time; and
a transmitter to transmit the third medium to an electronic device in the first base.

2. The medium processing device according to claim 1, wherein;
the transmission delay time is a value of a difference between the second time and the first time, and
the processing circuitry changes the processing mode based on a value of the difference.

3. A medium processing device of a second base different from a first base, the medium processing device comprising:
a first receiver that receives, from an electronic device in a third base, notification regarding a transmission delay time based on a second time associated with reception, by an electronic device in the third base, of a packet regarding a medium acquired in the second base at a time at which a medium acquired at a first time in the first base is reproduced in the second base and a third time at which a medium acquired at the first time in the first base is reproduced in the third base;
a second receiver that receives a packet that stores a first medium acquired in the first base from an electronic device in the first base and outputs the first medium to a presentation device;
a processing circuitry that generates a third medium from a second medium acquired in the second base at a time at which the first medium is reproduced in the second base according to a processing mode based on the transmission delay time; and
a transmitter that transmits the third medium to an electronic device in the third base.

4. The medium processing device according to claim 3,
wherein;
the transmission delay time is a value of a difference between the second time and the third time, and
the processing circuitry changes the processing mode based on a value of the difference.

5. The medium processing device according to claim 2, wherein;
the processing circuitry changes the processing mode so as to lower quality of a medium as a value of the difference increases.

6. A medium processing method, comprising:
receiving, from an electronic device in the first base, notification regarding a transmission delay time based on a first time at which a medium is acquired in the first base and a second time associated with reception, by an electronic device in the first base, of a packet regarding a medium acquired in the second base at a time at which the medium is reproduced in the second base;
receiving a packet that stores a first medium acquired in the first base from an electronic device in the first base;
outputting the first medium to a presentation device;
generating a third medium from a second medium acquired in the second base at a time at which the first medium is reproduced in the second base according to a processing mode based on the transmission delay time; and
transmitting the third medium to an electronic device in the first base.

7. (canceled)

8. A non-transitory computer readable storing a medium processing program for causing a computer to perform the method of claim 6.
